(19) United States
(12) Patent Application Publication
(10) Pub. No.: US 2025/0189831 A1
(43) Pub. Date: Jun. 12, 2025

(54) Optical Encoders

(71) Applicant: Optalysys Ltd., Leeds, West Yorkshire (GB)

(72) Inventor: Iman Kundu, Castleford, Yorkshire (GB)

(21) Appl. No.: 18/844,530

(22) PCT Filed: Mar. 7, 2023
(86) PCT No.: PCT/GB2023/050539

§ 371 Date: Sep. 6, 2024

(30) Foreign Application Priority Data
Mar. 7, 2022 (GB) 2203136.3

(51) Int. Cl. G02F 1/01

(52) U.S. Cl. CPC G02F 1/0121; G02F 2203/50

(57) ABSTRACT

There is provided a controller of an optical encoder, the controller configured to: receive an electronic signal, wherein a value of the electronic signal is based on a complex element; receive a feedback signal based on a phase drift associated with a photonic device of the optical encoder; modify the received electronic signal based on the received feedback signal to generate a modified electronic signal; and supply the modified electronic signal to modulate the photonic device.

### FIELD

The present disclosure relates to methods and devices for controlling an optical encoder. The optical encoder encodes and decodes complex numbers to and from optical signals, and performs arithmetic using optical circuits.

### BACKGROUND

Optical computing approaches promise to perform mathematical operations at much higher speeds whilst consuming much lower energy compared with performing similar operations using digital electronics. Nevertheless, optical computing systems are typically designed to be compatible with integer numbers only and are limited by the digital interface with existing hardware. It would be beneficial to provide an optical computing system capable of performing more sophisticated operations.

### SUMMARY

This overview introduces concepts that are described in more detail in the detailed description. It should not be used to identify essential features of the claimed subject matter, nor to limit the scope of the claimed subject matter.

The methods disclosed herein relate generally to systems and methods for providing improved optical computing systems capable of performing operations that are significantly more complex than those performed by existing optical computing systems. As optical computing systems become more sophisticated, various factors and requirements need to be addressed and compensated for to enable the improved optical computing systems to run reliably and efficiently. Further, it is desirable that controllers and control circuits are compatible with multiple types of photonic device, so that each type of photonic device does not require its own bespoke control circuit. The present disclosure provides mechanisms for addressing these objectives.

In more detail, the present inventors have recognised that as optical computing systems become more sophisticated, for example so as to be compatible with computations involving complex numbers, the optical computing systems become sensitive to phase changes and phase effects operating within/on components of the optical computing system. These phase effects must be compensated for to ensure the accuracy of the computations being performed. The present disclosure provides methods and devices directed to a controller of an optical encoder, such as may be used as part of an optical computing system, which is able to account for such phase effects.

The present inventors have also recognised that an array of photonic device types may need to be used in optical computing systems. It is desirable that controllers their control circuits are able to be easily adjusted to accommodate different types of photonic device. This avoids the need to provide a distinct controller type to match every possible photonic device type.

According to a first aspect of the present disclosure, there is provided a controller of an optical encoder, the controller configured to: receive an electronic signal, wherein a value of the electronic signal is based on a complex element; receive a feedback signal based on a phase drift associated with a photonic device of the optical encoder; modify the received electronic signal based on the received feedback signal to generate a modified electronic signal; and supply the modified electronic signal to modulate the photonic device. It will be apparent that there may be more than one controller and more than one photonic device. Controllers and photonic devices may operate together in the manner described in a one-to-one relation, a one-to-many relation or a many-to-one relation. Thus, references to “the/a controller” may be interpreted as a reference to “one or more controllers” and references to “the/a photonic device” may be interpreted as references to “one or more photonic devices”.

A “complex element” in this context may be understood to mean a complex number or a component of a complex number. The component of the complex number can be a real part or an imaginary part of a complex number or can be based on the real part or imaginary part of the complex number (for example the component could be the modulus of the real or imaginary part of the complex number or the positive or negative value of the real or imaginary part of the complex number).

In the manner just described, the controller is able to compensate for phase drift of a photonic device of the optical encoder. As described above, such phase drift effects may otherwise compromise the capacity of the photonic device (and by extension the optical computing system as a whole) for performing accurate and reliable computations and calculations. By receiving a feedback signal pertaining to the phase drift and using this to modify the input signal to the photonic device, a feedback loop may be established which may, in some arrangements, continuously or periodically update the electronic signal as required. Any phase drift of the photonic device may thus continuously or periodically be compensated for, ensuring reliable and accurate computation.

The feedback signal may be received as an offset voltage provided via feedback logic. In this manner, information about a phase drift of the photonic device may be received and processed by feedback logic, and said feedback logic may then be configured to provide an appropriate correction to the electronic signal in the form of an offset voltage provided to the controller. In this manner, the feedback logic can be adapted as required based on the type of photonic device being used as well as to account for any other requirements which may impact the desired correction to the electronic signal.

The controller may be configured to split the received electronic signal into a first signal component and a second signal component. This can advantageously enable the first and second signal components to be treated differently and, optionally, to encode different information as will be described in more detail below.

The second signal component may be an inverted version of the first signal component. This is done to increase the dynamic operating range of the photonics devices, and to reduce the quantisation noise from such devices; which in turn improves the bit-precision/accuracy/addressable limits of said photonics devices.

The controller may invert the second signal component of the split signal in the digital domain or the analogue domain. For example, in one arrangement the controller may comprise a push-pull amplifier configured to invert the second signal component in the analogue domain. In another arrangement, the controller may comprise an inverter configured to invert the second signal component in the digital domain. If the second signal component is inverted in the digital domain, the circuit may advantageously be simplified. This is due to the fact that inverting in the analogue domain may require further circuitry components, for example the need for a push-pull amplifier. Such a push-pull amplifier may remove AC coupling or add a DC artefact to the second signal component which may need be corrected for using the further circuitry. Inverting the second signal component in the digital domain avoids the need for such corrections and associated components. However, inverting the digital signal requires two digital-to-analog converters, which can increase power consumption. The trade-off between designs is reached by considering the overall electrical power budget of the electronic circuit.

The controller may be configured to receive an adjustment signal to correct a DC offset on the second signal component and modify the second signal component based on the received adjustment signal to generate a modified second signal component. Correcting the DC offset or correcting any DC artefacts advantageously ensures that the second signal component maintains AC coupling. AC coupling results in the DC component or the DC offset of a signal being removed so the resolution of the signal can increase. This AC coupling may be particularly advantageous when dealing with a high frequency signal or when there is a large DC offset.

The controller may be configured to modify the received electronic signal by adjusting the first and second signal components to offset the phase drift associated with the photonic device. This is one mechanism by which the controller may compensate for the phase drift of the photonic device. Compensating at the level of the split signal components provides a finer level of control, precision and flexibility. For example, the first signal component may be used to carry a data signal to the photonic device(s) while the second signal component may be used to interpret and correct for phase drift effects of the photonic devices. In such an example, the second signal component can then be used to modify the first signal component as needed to compensate for the phase drift.

The controller may be configured to modify the received electronic signal by adjusting the first and second signal components such that their swing voltage spans a dynamic operating range of the photonic device. This adjustment advantageously enables the voltage to swing close to its maximum or swing rail-to-rail while the waveform is not clipped. This enables signal distortion to be reduced and amplitude of the output signal to be increased.

The controller may be configured to receive an indication of a dynamic operating range of the photonic device and modify the received electronic signal based on the received indication of the dynamic operating range. This further enables the signal provided to the photonic device to account for the operating parameters and limitations of the photonic device, ultimately enabling improved control and, as a result, more accurate and reliable calculation and computation. Adjusting the signal based on a dynamic operating range of the photonic device also again enables the voltage to swing close to its maximum or swing rail-to-rail while the waveform is not clipped, again enabling signal distortion to be reduced and amplitude of the output signal to be increased.

The controller may be configured to amplify the received electronic signal. Signal amplification in this manner advantageously allows the output signal to have a higher amplitude without changing the shape of the input signal. Amplification also helps to minimise the effects of signal noise or interference.

The received electronic signal may be a digital electronic signal. The controller may be configured to convert the received (digital) electronic signal to an analogue electronic signal, using a digital to analogue converter (DAC).

The controller may be configured to AC couple the analogue electronic signal to adjust a DC offset of the analogue electronic signal. Correcting the DC offset or correcting any DC artefacts advantageously ensures that the signal maintains AC coupling. AC coupling results in the DC component or the DC offset of the signal being removed so the resolution of the signal can increase. This AC coupling may be particularly advantageous when dealing with a high frequency signal or when there is a large DC offset.

The controller may be configured to modify the received electronic signal to compensate for a phase shift induced by a push-pull amplifier of the optical encoder. This enables the system to compensate for undesirable phase effects induced by the push-pull amplifier to be corrected. Such phase effects may otherwise impair the optical computing system's capacity to make accurate and reliable computations and calculations.

The controller may be configured to supply the modified electronic signal by: supplying a first portion of the modified electronic signal, wherein the first portion is fast moving; and supplying a second portion of the modified electronic signal, wherein the second portion is slow moving. In this context, “fast moving” signals describe AC data signals. In this context, “slow moving” signals describe slow moving DC signals. Slow moving components of a circuit may generally comprise DC components.

In one arrangement, the fast-moving signal may comprise a data signal while the slow-moving signal may comprise a correction signal. In this manner, the fast-moving signal may carry data to the photonic device quickly, whilst the slow-moving signal can encode the correction prompted by the received feedback signal. The slow-moving signal can then be used to modify the fast-moving signal as needed. This is beneficial because phase drift of the photonic device occurs slowly, and so a slow-moving signal is sufficient to capture and correct for these phase effects. Phase drifts can only be corrected as they occur so a fast-moving signal would be less appropriate for correcting phase drift. In the meantime, the fast-moving signal can continue to transfer data to the photonic device at a fast rate.

Modifying the received electronic signal may generate the second portion of the modified electronic signal. The received electronic signal may be a multi-bit signal. The received electronic signal may be received via an interface and at least one buffer. The interface may comprise a digital input and output board.

According to a second aspect of the present disclosure, there is provided an electronic to optical encoder comprising: a controller as described herein and a photonic device as described herein. The photonic device comprises a modulator configured to apply a first element of modulation to an optical input signal based on the modified electronic signal and the first element of modulation is operable to encode the complex element onto the optical input signal to produce an encoded optical signal.

According to a third aspect of the present disclosure, there is provided a method for performing by a controller of an optical encoder, the method comprising: receiving an electronic signal, wherein a value of the electronic signal is based on a complex element; receiving a feedback signal based on a phase drift associated with a photonic device of the optical encoder; modifying the received electronic signal based on the received feedback signal to generate a modified electronic signal; and supplying the modified electronic signal to modulate the photonic device.

The present disclosure relates generally to improved optical computing systems which are able to perform operations of increased complexity. More specifically, the present disclosure provides methods and devices which allow an optical computing system to compensate for phase effects affecting components of the system. These phase effects do not adversely impact more rudimentary optical computing systems, however the present inventors have recognised that they must be accounted for as the complexity of optical computing systems increases. Compensating for these effects ensures reliability and accuracy of the computations performed by the optical computing system.

### BRIEF DESCRIPTION OF THE DRAWINGS

Specific embodiments are described below by way of example only and with reference to the accompanying drawings in which:

FIGS. 1a-1c are Argand diagrams including plots of complex numbers;

FIG. 2 shows photonic circuit components (modulators), their photonic function and the mathematical operator which they apply to complex elements in the optical domain;

FIG. 3a shows a method of encoding a full complex number onto an optical input signal according to embodiments;

FIG. 3b shows an optical encoder according to embodiments;

FIG. 4a shows an optical encoder including a controller according to embodiments;

FIGS. 4b-4g show specific examples of the optical encoders of FIGS. 3b and 4a;

FIG. 5a shows an optical encoder according to embodiments;

FIGS. 5b-5f show specific examples of the optical encoder of FIG. 5a;

FIG. 6a shows an optical encoder according to embodiments;

FIGS. 6b and 6c show specific examples of the optical encoder of FIG. 6a;

FIGS. 6d and 6e respectively show graphs of magnitude and phase of an output of the encoders according to FIGS. 6a-6c as a function of the phase shift applied by each phase shifter;

FIGS. 7a and 7b show optical circuits including encoders, wherein the optical circuits are configured to perform arithmetic operations on encoded optical signals;

FIGS. 8a and 8b show optical decoders according to embodiments.

FIG. 9a is a schematic of an optical Fourier transform stage;

FIG. 9b is a schematic of a free-space optical Fourier transform stage having 2D input and output arrays;

FIG. 9d is a schematic of an integrated optical Fourier transform stage having 1D input and output arrays;

FIG. 9c is a close up schematic showing the 2D input/output array of FIG. 9b and the 1D input/output array of FIG. 9d;

FIG. 10a is a schematic of an optical apparatus according to embodiments;

FIG. 10b is a schematic showing a mathematical operation which can be performed using the optical apparatus of FIG. 10a;

FIG. 11 is a schematic of an optical apparatus according to embodiments;

FIG. 12 is a schematic showing a mathematical operation which can be performed using the optical apparatus of FIG. 11;

FIG. 13 is a schematic showing a mathematical operation which can be performed using optical Fourier transform stages according to embodiments;

FIG. 14 shows an example of a system for correcting phase effects in an encoder;

FIGS. 15 and 16 respectively illustrate first and second example embodiments showing flows of signals through components of a controller 1402 of an optical encoder;

FIG. 17 is an example circuit for use in implementing the controller of FIG. 15;

FIG. 18 shows a flow chart of a method which may be implemented by a controller in order to supply an input signal to a photonic device;

FIGS. 19 and 20 show circuits for processing optical signals received by decoders according to embodiments; and

FIGS. 21 and 22 show detailed examples of the operation of a differential ADC and binary output decoder in FIGS. 19 and 20.

In the Figures, like reference numerals refer to like parts.

### DETAILED DESCRIPTION

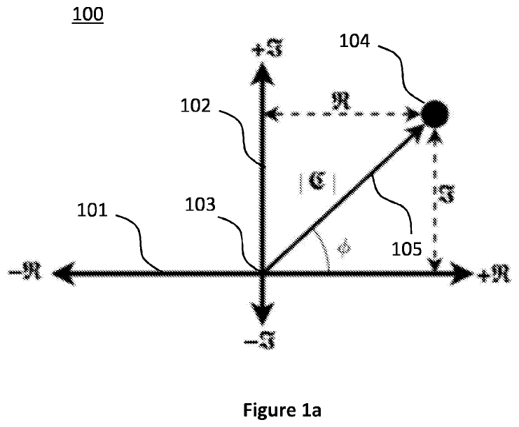

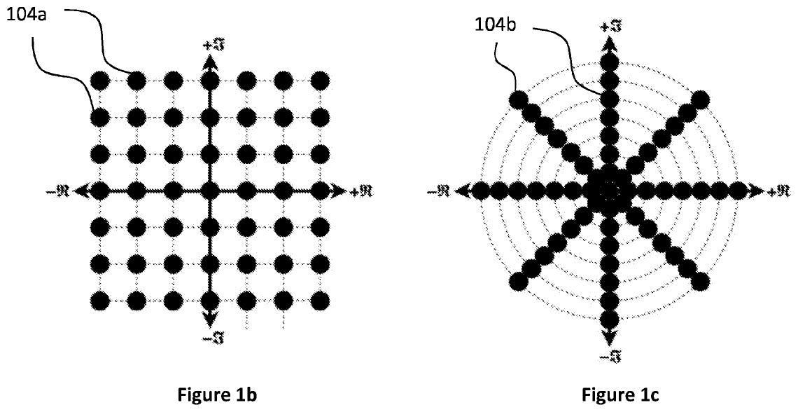

The present disclosure begins, with reference to FIGS. 1-8b, by describing encoders arranged to encode complex elements onto optical signals, optical circuits for performing mathematical operations on complex elements and decoders arranged to decode complex elements from optical signals. The term ‘complex element’ when used in the present disclosure may be understood to mean a complex number or a component of a complex number. The component of the complex number can be a real part or an imaginary part of a complex number or can be based on the real part or imaginary part of the complex number (for example the component could be the modulus of the real or imaginary part of the complex number or the positive or negative value of the real or imaginary part of the complex number).

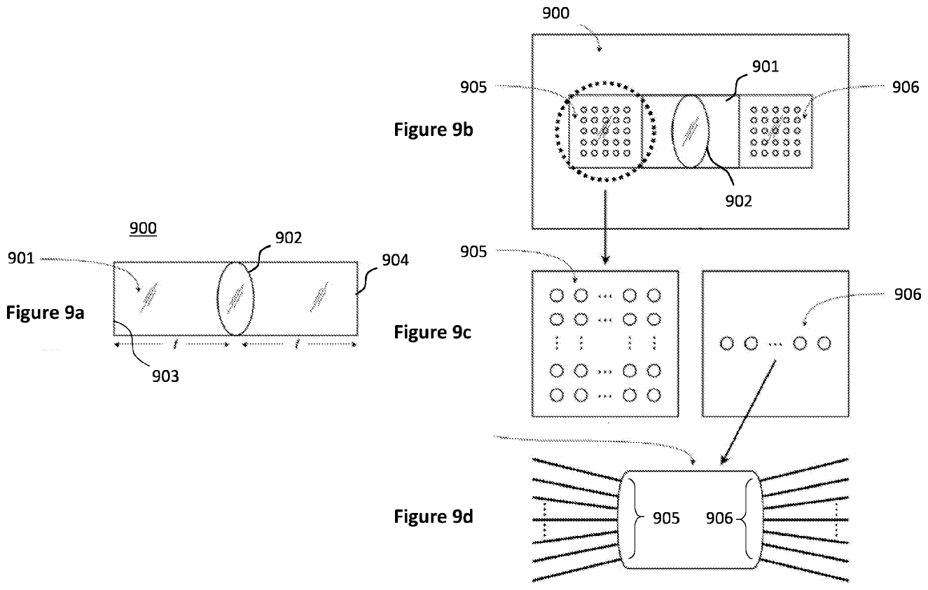

Following this, FIGS. 9a-13 describe optical apparatuses (e.g. photonic integrated circuits) capable of performing complex operations including arithmetic, optical Fourier transforms (OFTs) and convolutions, where each of these are performed using complex elements, and in which full complex numbers are decoded from any output signal. Such operations provide the basis for numerous computing intensive applications such as cryptography, artificial intelligence, and scientific simulations inter alia. The photonic architecture provided as part of the optical computing system natively operates on multi-bits of information and is suited not only for Silicon Photonics (SiPh) platform but also III-V semiconductor material systems or any integration of the two.

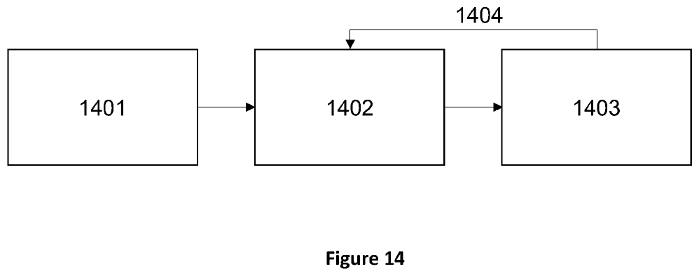

Following description of these optical computing systems, methods and devices are then described with reference to FIGS. 14-22. This includes the electronic circuitry which controls the encoders and aids in the decoding of complex numbers from signals received at the decoders. Elements of these electronic circuits compensate for phase effects which impact optical computing systems of increased sophistication such as those of the present disclosure.

### I—Encoders, Decoders and Optical Circuits

### Encoding Complex Mathematical Numbers Using Photonics

A complex mathematical number can be encoded onto an optical signal emanating from a coherent light source. A complex number [symbol] is encoded either using cartesian coordinates by defining the complex number using its real [symbol] and imaginary ℑ components (equation 1a), or using polar coordinates by defining the complex number using its magnitude | [symbol] | and phase (henceforth referred to as ‘argument’) φ (equation 1b).

$$\begin{matrix} & = & + j & ( equation 1 a ) \\ & = & \vert \vert exp ( j φ ) & ( equation 1 b ) \\ & & & \end{matrix}$$

As shown in FIG. 1a, an Argand diagram 100 can be defined by a first axis 101 and a second axis 102 orthogonal to the first axis 101 so that the angular relationship between the positive arm of the second axis 102 and the positive arm of the first axis 101 is π/2 radians. The intersection of the first and second axes 101, 102 defines an origin 103 of the Argand diagram 100. The first axis 101 represents the real dimension and the second axis 102 represents the imaginary dimension. A complex number 104 is defined as a point on the Argand diagram.

It is helpful to define the complex number 104 and its position on the Argand diagram 100 using a vector 105 which originates at the origin 103 and terminates at the point representing the complex number 104. The vector can be defined by the vector sum of its projections onto first and second axes 101, 102. The projections respectively define the real ( [symbol] ) and imaginary (ℑ) components in cartesian coordinates. Alternatively, the vector 105 can be defined as having a magnitude (or modulus or absolute value) | [symbol] | measured as the length of the vector 105 and argument φ measured as the angle swept out from the first axis 101 to the vector 105.

Each of the real and imaginary components [symbol] , ℑ can be simplified into its absolute value abs( [symbol] ), abs(ℑ) multiplied by its the polarity (or sign) sign( [symbol] ), sign(ℑ), as shown in equations 2a and 2b, respectively:

$$= abs ( ) \cdot sign ( ) \qquad ( equation 2 a )$$

$$= abs ( ) \cdot sign ( ) \qquad ( equation 2 b )$$

FIGS. 1b and 1c each illustrate an Argand diagram with the same properties as the Argand diagram 100 of FIG. 1a, each representing an array of complex numbers 104a, 104b for a system that is capable of encoding the complex numbers 104a, 104b with a fixed intervals in quantisation level NV for each component. As shown in the comparison of FIGS. 1b and 1c, representing a complex number [symbol] in cartesian coordinates (FIG. 1b) provides a complex plane (complex number domain) with an equidistant rectangular grid, whereas representing a complex number [symbol] in polar coordinates (FIG. 1c) provides a less uniform resolution over the complex number domain because the resolution of the system is more dense when close to the origin and more sparse in the argument domain as the magnitude | [symbol] | of the complex number [symbol] increases. Although not discussed in detail here, another prominent space on which the coordinates may be projected is the two-dimensional surface of a Riemann sphere. However, this can also present problems with uniform resolution when using fixed intervals in quantisation level. Therefore, although encoding in each of these spaces is possible, encoding in cartesian co-ordinates has advantages in a quantised (or digital) encoding system which has a fixed interval in quantisation level N of the components.

Although the complex domain as shown in FIGS. 1a-1c is represented in cartesian coordinates having orthogonal axes, it is also possible to represent the complex domain using axes arranged at an oblique angle such that the angle between them is greater than zero and less than 90 degrees. That is, the phase difference (or argument difference) between the real and imaginary parts is no longer π/2 radians, but a number greater than 0 radians and less than π radians. A conversion matrix can be used to map complex numbers from one set of axes to the other.

The inventors have recognised that, by manipulating one or a combination of photonic devices based on a quantised (or digital) electronic signal, an optical signal modulated by the photonic devices can be encoded with a mathematical complex number (or at least a component of a complex number). The complex number (or component thereof) originates in the digital electronic domain but is encoded in the optical domain for processing there. For example, the constituent terms on the right hand sides of equations 1a-2b can be represented in the optical domain by encoding the terms onto an optical signal. A digital electronic signal having values based on said terms is converted into an analogue signal to drive one or a combination of photonic devices to modulate an optical input signal to produce an optical signal encoded with said terms. The use of a received digital electronic signal encoded with complex numbers and the subsequent transmutation of the data onto an optical signal output by photonic devices (which typically operate in an analogue manner) creates an improved interface between the digital signal domain used in electronic computing, and the optical domain used in optical computing. In particular, the splitting up of a digital word defining a complex element into segments, then the separate use of these segments to control separate modulators to encode the whole complex element onto the optical stream, is a more efficient and controllable means of encoding optical signals with complex elements. This allows optical computer processors to be integrated more easily, efficiently and effectively with electronic computer processors.

Photonic circuit components (also referred to herein as photonic devices or modulators) are used to modulate the phase or amplitude of an optical signal to encode a complex element (e.g. a complex number or a component thereof) onto the optical signal, and/or to combine or otherwise process optical signals to perform mathematical operations such as addition, multiplication, Fourier transform and convolution on complex numbers or components thereof.

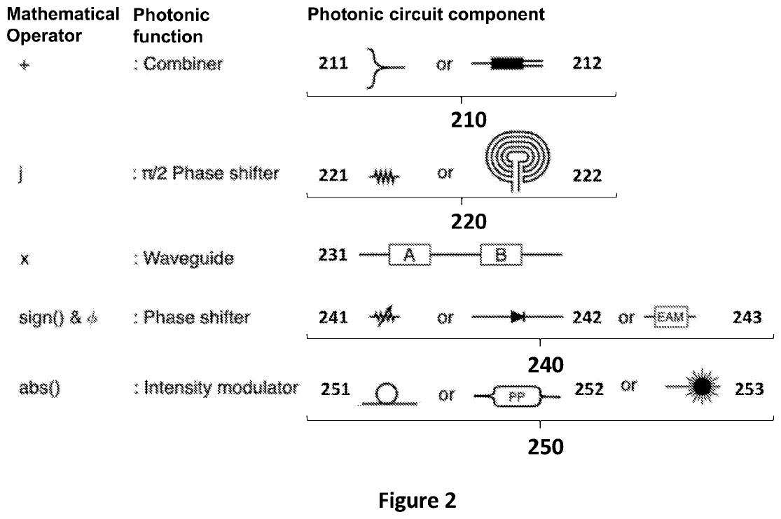

FIG. 2 shows a variety of photonic circuit components, their photonic functions and the mathematical operations which they encode (or impart) onto an optical signal.

As illustrated in FIG. 2, addition of complex numbers (or components thereof) in the optical domain is performed using Y-branches 211 or 2×1 multimode interferometers (MMI) 212, or a combination of either or both in parallel.

A phase shift of π/2 (for example to introduce orthogonality between real and imaginary terms [symbol] , ℑ in different branches of an optical circuit) by a π/2 phase shifter 220 can be encoded onto an optical signal using either current/voltage driven phase shifters 221 exploiting thermal effects, plasma dispersion effects, Franz-Keldysh effects, or electro-absorption effects; or by delay lines 222, or a combination of both.

Multiplication of complex numbers, or components thereof, already encoded onto an optical signal can be performed in the optical domain by simply cascading photonic elements representing numbers in series in a branch 231 of an optical circuit.

The polarity or sign of a complex number (or component thereof) can be encoded onto an optical signal by imparting a fixed phase shift of π by a phase shifter 240, for example using any one or more of a thermal phase shifter 241, a carrier depletion phase shifter 242 or an electro absorption phase shifter 243. Phase shifters may also be phase switches.

The absolute value or modulus of a complex number (or component thereof) can be encoded onto an optical signal by an intensity modulator 250, such as micro-ring resonator (MRR) 251, Mach-Zehnder interferometer (MZI) 252 operating in push-pull mode, electro-absorption modulator (EAM) or direct intensity modulated laser (DIML) 253.

The devices listed above and shown in FIG. 2 may be realised using Silicon Photonics or III-V Photonics, or a combination of both. By using a combination of these devices, some or all of the terms in equation 1a-2b can be encoded onto an optical signal using photonic integrated circuits (also referred to herein as PIC architectures, encoders, or electrical to optical encoders).

Moreover, PIC architectures are made modular by:
Encoding a full complex number using photonics.
Encoding signed real and imaginary components of complex numbers in photonics and adding them together.
Encoding unsigned real and imaginary components of complex numbers in photonics and adding them together

### Encoding Complex Mathematical Number in Cartesian Coordinate Using Photonics

A complex number represented in cartesian coordinates is encoded in the optical domain by encoding the signed real and the signed imaginary terms of the complex number separately and adding the two together.

In all figures showing the encoding circuits, the optical signal propagation is from left to right.

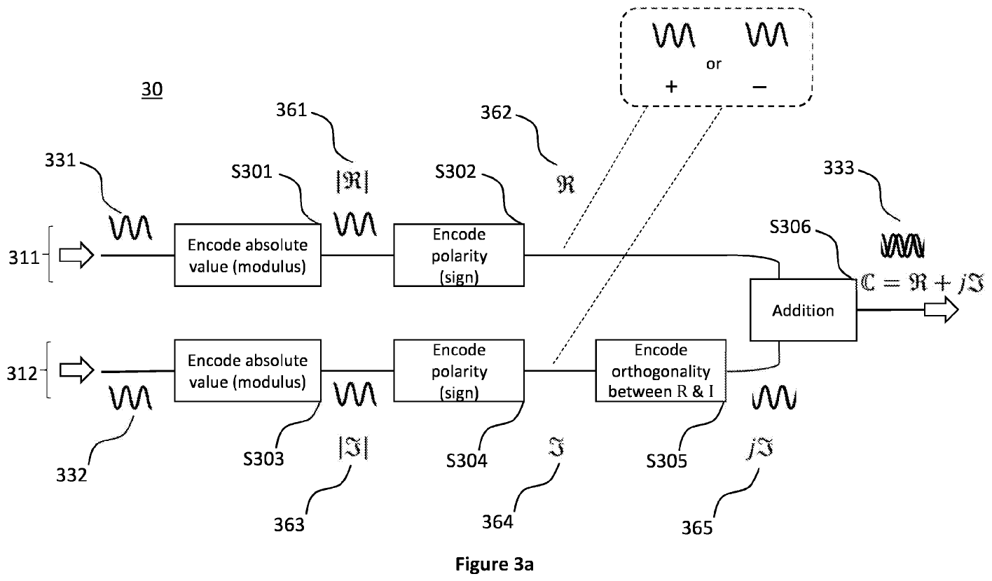

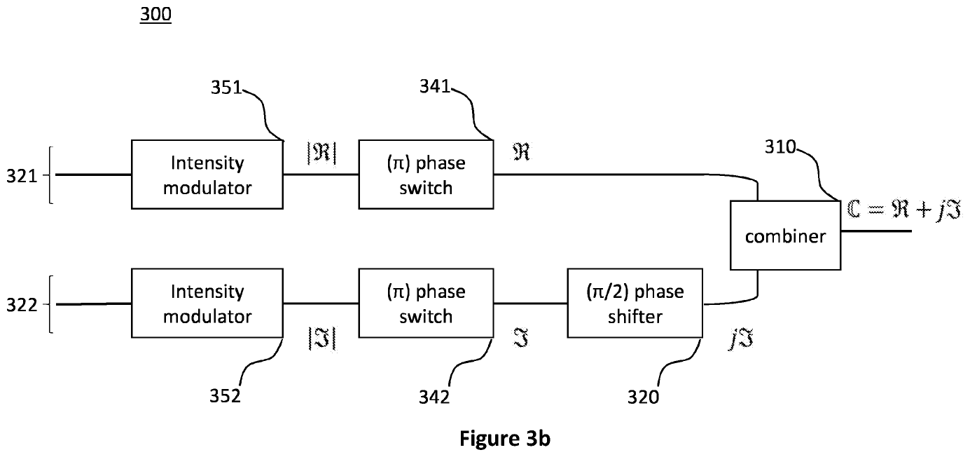

FIG. 3a is a schematic showing a process 30 of encoding a complex number [symbol] in the optical domain by modulating and combining input optical signals to form an optical output signal.

A first optical input signal 331 is received in a first series branch 311 of an optical circuit and a second optical input signal 332 is simultaneously received in a second series branch 312 of the optical circuit. In a first step S301, the first input signal 331 is encoded with an absolute value | [symbol] | of a first component [symbol] of a complex number [symbol] to produce a first amplitude modulated signal 361. In a second step S302, the first amplitude modulated signal 361 is encoded with a polarity (or sign) to produce a first intermediate signal 362. In a third step S303, the second input signal 332 is encoded with an absolute value |ℑ| of a second component ℑ of a complex number [symbol] to produce a second amplitude modulated signal 363. In a fourth step S304, the second amplitude modulated signal is encoded with a polarity or sign to produce a second intermediate signal 364. In a fifth step S305, the second intermediate signal 364 is encoded with a phase shift to produce a phase shifted signal 365, the phase shifted signal being orthogonal to the first intermediate signal 362. In a sixth step S306, the first intermediate signal 362 and the phase shifted signal 365 are added together to form an output signal 333.

The output signal 333 is encoded with a complex number [symbol] of the form shown in equation 1a. The first amplitude modulated signal 361 represents an unsigned real component of a complex number | [symbol] |, constituting the modulus of the real part [symbol] of the complex number [symbol] . The first intermediate signal 362 represents a real number [with a sign (+or −)] + [symbol] or − [symbol] constituting the real part (or component) [symbol] of the complex number [symbol] . The second amplitude modulated signal 363 represents an unsigned imaginary component |ℑ|, constituting the modulus of the imaginary part ℑ of the complex number [symbol] . The second intermediate signal 364 represents a real number [with a sign (+or −)] +ℑ or −ℑ constituting the imaginary part ℑ of the complex number [symbol] . The phase shifted signal 365 represents the imaginary part ℑ multiplied by the indeterminate j, where j=\sqrt{−1} (i.e. j is a complex number whose square is −1).

In mathematical terms, the absolute values of the real and imaginary terms are multiplied by the polarity of the real and imaginary terms, respectively. A relative argument of (2n−1)π/2 the real and imaginary terms is offset by (2n−1)π/2, where n is an integer. The real and imaginary terms are then added together to form the complex number.

The first input signal 331 and second input signal 332 are coherent. This ensures the output signal 333 can be accurately encoded with the complex number [symbol] .

Although FIG. 3a shows the first and third steps S301, S303 occurring prior to the second and fourth steps S302, S304, respectively, the order of these steps can be reversed so that the sign is encoded prior to the absolute value in one or both of the first and second series branches 311, 312.

The third and fourth steps S303, S304 are optional since the real and imaginary parts [symbol] , ℑ of the complex number [symbol] may both be positive. That is, in the case of a positive value for the encoded real and imaginary parts [symbol] , ℑ there is no further modulation of the first and second amplitude modulated signals 361, 363 necessary in the second and fourth steps S302, S304, which steps therefore become redundant. As will be described later with reference to FIG. 3b, one appropriate way of realising such an optional modulation of the sign of the signal is by using a phase switch.

Although the fifth step S305 is shown as occurring in the second series branch 312, this step can occur in the first series branch 311 instead, or otherwise can occur in part in the first series branch 311 and in part in the second series branch 312. The purpose of the fifth step S305 is to provide orthogonality (in the complex domain in e.g. FIG. 1a) between signals emerging from the first and second series branches 311, 312. That is, the fifth step S305 involves imparting a phase difference of (2n−1)π/2 between the signals in the first and second series branches 311, 312 before they are added together. This can happen in the second series branch 312 by adding a phase shift of e.g. (2n−1)π/2 onto the second intermediate signal or can happen in the first series branch 311 by adding a phase shift of e.g. −(2n−1)π/2 onto the first intermediate signal. Alternatively, the fifth step S305 can occur by adding a phase shift of e.g. −(2n−1)π/4 onto the first intermediate signal and a phase shift of e.g. (2n−1)π/4 onto the second intermediate signal so that the total phase shift between the first and second series branch 311, 312 is (2n−1)π/2.

Furthermore, although the fifth step S305 is shown as occurring between the fourth step S304 and the sixth step S306, the fifth step S305 may be performed at any stage before the sixth step S306, for example the fifth step S305 may be performed in the first series branch 311 before the first step S301 or in the second series branch 312 between the second and fourth step S302, S304. As the reader will understand, the nomenclature first, second, etc. when used with respect to the steps is a convenient labelling convention but is not necessarily limiting as to when steps can be performed relative to each other.

Further still, although orthogonality (provided by the phase shift of (2n−1)π/2) radians provides a convenient convention or mathematical construct for encoding the complex number [symbol] , it is possible to encode a complex number [symbol] without a phase shift of (2n−1)π/2 radians provided that there is an angle between the axes of the complex domain which is greater than zero and less than π (as explained earlier with reference to a skewed version of the Argand diagram in which the angle between the real and imaginary axes is greater than zero but less than π radians). Detecting a complex number [symbol] encoded in this way is more difficult than if an orthogonal relationship exists between the real and imaginary axes. This is because compensation, usually involving application of a scale factor between the two axes, must be employed to take into account the new angular relationship between the axes in the chosen (non-conventional) complex plane.

The method of FIG. 3a can be realised with the exemplary encoder 300 shown in FIG. 3b. The encoder includes a first series branch 321 and a second series branch 322. The first series branch 321 includes a first intensity modulator 351 and a first phase switch 341. The second series branch 322 includes a second intensity modulator 352 and a second phase switch 342. The encoder further comprises a combiner 310 arranged to combine a first output [symbol] from the first series branch 321 and a second output ℑ from the second series branch 322 to produce the optical signal encoded with the complex number [symbol] . The second series branch 322 may further include a phase shifter 320 arranged to encode the second output with a phase shift to produce a phase shifted signal jℑ so that the first output and second output are orthogonal.

In the encoder 300 of FIG. 3b, the first and third steps S301, S303 (from FIG. 3a) are carried out by the first and second intensity modulators 351, 352, respectively. The second and fourth steps S302, S304 are carried out by the first and second phase switches 341, 342, respectively. The fifth step S305 is carried out by the phase shifter 320 and the sixth step S306 is carried out by the combiner 310. The signals processed and produced are as described with reference to FIG. 3a. As the skilled reader will understand, all described variations of the method of FIG. 3a are possible by arranging the first and second intensity modulators 351, 352, first and second phase switches 341, 342 and phase shifter 320 in various positions in the first and second series branches 311, 312 to achieve the various methods described herein in relation to FIG. 3a. For example, the order of the first intensity modulator 351 and first phase switch 341, or the second intensity modulator 352 and second phase switch 342, can be reversed and/or the phase shifter 320 can be incorporated into either of the first and second series branches 321, 322 as a standalone component or as a component which is integrated into any one or more of the first intensity modulator 351, second intensity modulator 352, first phase switch 341 or second phase switch 342. As with any of the photonic components described herein for encoding optical signals, the first intensity modulator 351, second intensity modulator 352, first phase switch 341 or second phase switch 342 may be described more generally as modulators.

The encoder 300 of FIG. 3b may be passive in the sense that the first and second intensity modulators do not receive any control signals and are instead set up to apply fixed intensity modulations to the first and second input signals 331, 332, respectively. Likewise the first and second phase switches 341, 342 may be passive in that they do not receive any control signals and apply fixed phase shifts (or no phase shift) to the first and second input signals 331, 332. Similarly, the π/2 phase shifter 320 is passive and does not receive any control signals nor applies any phase shift to the first and/or second input signal 331, 332.

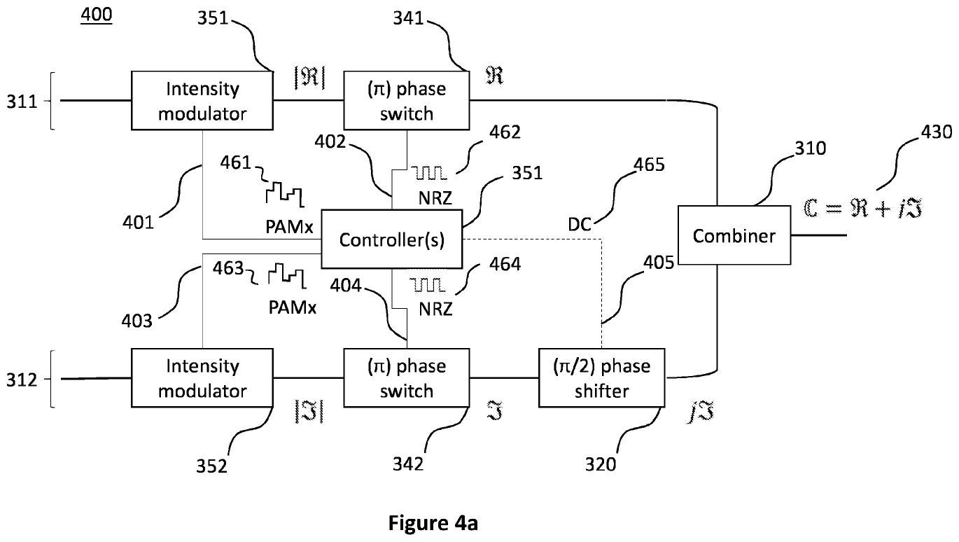

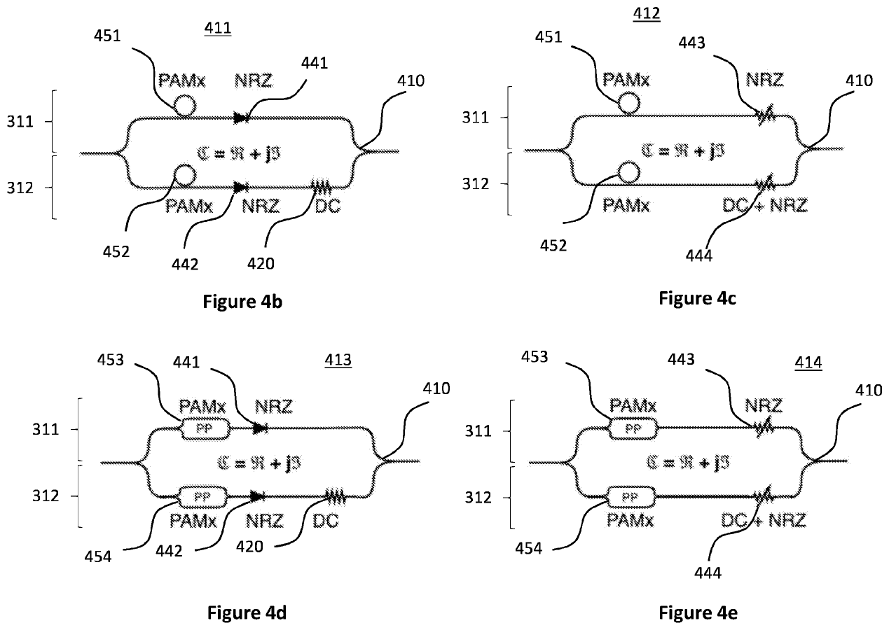

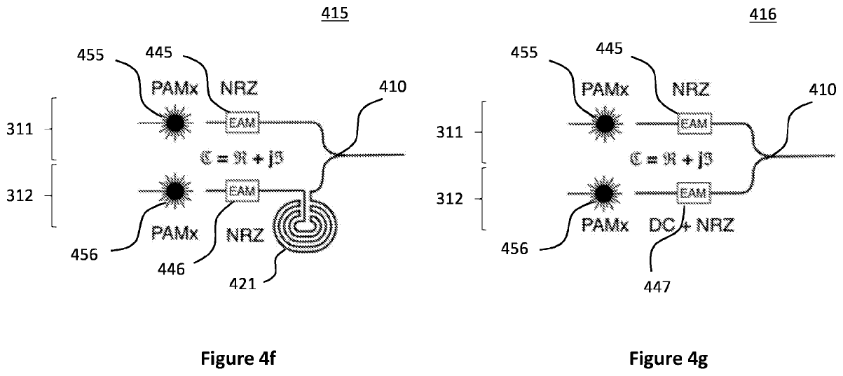

A passive encoder can be useful where the same complex number [symbol] must always be encoded by the encoder 300. However, as will be described with reference to FIG. 4a, it can be useful to provide an active encoder which can encode any given complex element onto an optical signal on the basis of a received digital electronic signal carrying information based on the value of the complex element. An active encoder allows the first and/or second intensity modulators 351, 352, and first and second phase switches 341, 342 to be addressable to provide different amplitude and phase modulations in order to encode different absolute values and signs onto the first and second input signals 331, 332 and thereby encode real and imaginary components [symbol] , ℑ of the complex numbers [symbol] to have different values.

FIG. 4a shows the encoder 300 of FIG. 3b as part of a system 400 including a controller 460. The controller 460 is arranged to receive digital electronic signals and control the components 351, 341, 352, 342 of the encoder based on values of the digital electronic signals 461, 462, 463, 464 and thereby control the value of the complex number [symbol] encoded onto the optical signal output 430 from the encoder.

A digital word contains the sign and magnitude of either the real or imaginary component of a complex number, or sign and magnitude of both of the real and imaginary components thereby forming the full complex number. The received digital signals in all of the encoders described herein are segments of that digital word. The controllers generate PAMx, NRZ, DC, or any combination of these signals to control the components 351, 341, 352, 342 of the encoder. The controller may do so by creating PAMx, NRZ or DC analogue electronic signals based on the received digital data (i.e. the segments of the digital word) and supplying the analogue electronic signals to the modulators. The PAMx, NRZ and DC signals may be described as quantised analogue signals.

Therefore, the controller 460 is configured to supply: based on a value of a first digital electronic signal, a first electronic signal 461 via at least one first line 401 to the first intensity modulator 351; based on the value of a second digital electronic signal, a second electronic signal 462 via at least one second line 402 to the first phase switch 341; based on the value of a third digital electronic signal, a third electronic signal 463 via at least one third line 403 to the second intensity modulator 352; and, based on the value of a fourth digital electronic signal, a fourth electronic signal 464 via at least one fourth line 404 to the second phase switch 342. Optionally, the controller 460 can supply a DC electronic signal 465 via at least one fifth line 405 to the phase shifter 320. Alternatively, no signal is supplied to the phase shifter 320, and a passive component (such as a (phase) delay line 222) is used instead.

The first and third electronic signals 461, 463 are PAMx (pulse amplitude modulation) signals, where x is greater than 2 (i.e. a 4-level PAM (PAM4) or above). That is, the first and third electronic signal 461, 463 are multi-bit signals. The PAMx signals are single polarity signals. The higher the value of x, the greater the resolution of the first and second intensity modulators 351, 352 and the greater the accuracy of encoding of the absolute value of the first and second components [symbol] , ℑ of the complex number [symbol] .

The second and fourth electronic signals 462, 464 are NRZ (non-return-to-zero) signals (PAMx signals, where x is equal to 2). That is, the second and fourth electronic signals 462, 464 are single-bit, or binary, signals. This is because the first and second phase switches 341, 342 need only be toggled between two possible states. Each of the first and second phase switches 341, 342 are configured to: add a phase of 2nπ when the sign of the respective encoded component is positive; and add a phase of (2n−1)π when the sign of the respective encoded component is negative; where n is an integer. That is, each of the first and second phase switches 341, 342 adds a phase of zero or an even number of π when encoding positive values and adds an odd number of π when encoding positive values. Although not ideal, it is possible to encode positive and negative signals using other added phase values as long as the difference between the phase used to encode positive values and the phase used to encode negative values is π. Such a system would shift the overall output in terms of phase. If such a phase shift is undesirable, a phase compensator can be added elsewhere in the circuit to ensure that the signal encoded with a positive value is in phase with the input signal.

The format of signals controlling the photonic devices can be summarised as follows:
The absolute values (both real and imaginary terms) are modulated based on a multi-bit signal (such as an analogue PAMx signal quantised to have x levels, where x=2^{N} and N is the bit precision of the system) derived from the received digital data.
The polarity (both real and imaginary terms) is modulated based on a binary signal (such as an analogue NRZ signal quantised to have only two levels) derived from the received digital data.
The orthogonal argument offset between the real and imaginary terms is controlled using a variable direct current/voltage line that is not necessarily (though in some instances can be) dependent on the received digital data.

The method of FIG. 3a can be carried out using any one of the encoders 411, 412, 413, 414, 415, 416 shown in FIGS. 4b to 4g, which are more specific examples of the encoder 300 shown in FIG. 3b. Each of the encoders 411, 412, 413, 414, 415, 416 of FIGS. 4b to 4g is configured to perform the method 30 described with reference to FIG. 3a. Each of the encoders 411, 412, 413, 414, 415, 416 of FIGS. 4b to 4g can be connected to a controller 460 so as to supply the optical (photonic) components 320, 341, 342, 351, 352 with electronic signals, based on the received digital electronic signals 461, 462, 463, 464, 465 in the same way as described with reference to FIG. 4a.

The encoder 411 of FIG. 4b shows the use of microring resonators (MRRs) 251 as the intensity modulators 451, 452 to encode the absolute or modulus of both real and imaginary components of a complex number [symbol] , ℑ. Carrier depletion phase shifters 242 are used as phase switches 441, 442 to encode the polarity (or sign) of the real and imaginary components [symbol] , ℑ. The phase separation between the first series branch 311 and second series branch 312 is provided by a phase shifter 221 exploiting thermal effects which is used as a phase switch 420 to phase shift the imaginary component by π/2; and a Y-branch 211 or 2×1 MMI 212 (not shown) acts as the combiner 410 to add the real and imaginary components [symbol] , ℑ.

Similarly, the encoder 412 of FIG. 4c shows the use of MRRs 251 as intensity modulators 451, 452 to encode the absolute or modulus of both real and imaginary components of a complex number [symbol] , ℑ. Thermal phase shifters 241 are used as phase switches 443, 444 to encode the polarity (or sign) of the real and imaginary components [symbol] , ℑ. In this case, one of the phase switches 444 also performs the function of shifting the phase of the imaginary component by π/2 and so the controller 460 sends a DC signal overlaid with an NRZ signal to control the phase switch. A Y-branch 211 or 2×1 MMI 212 acts as the combiner 410 to add the real and imaginary components [symbol] , ℑ.

The encoder 413 of FIG. 4d shows the use of MZIs 252 as intensity modulators 453, 454 to encode the absolute or modulus of both real and imaginary components [symbol] , ℑ. Carrier depletion phase shifters 242 are used as phase switches 441, 442 to encode the polarity (or sign) of the real and imaginary components [symbol] , ℑ. The phase separation between the first series branch 311 and second series branch 312 is provided by a phase shifter 221 exploiting thermal effects which is used as a phase switch 420 to phase shift the imaginary component by π/2; and a Y-branch 211 or 2×1 MMI 212 (not shown) acts as the combiner 410 to add the real and imaginary components [symbol] , ℑ.

Similarly, the encoder 414 of FIG. 4e shows the use of MZIs 252 as intensity modulators 453, 454 to encode the absolute or modulus of both real and imaginary components [symbol] , ℑ. Thermal phase shifters 241 are used as phase switches 443, 444 to encode the polarity (or sign) of the real and imaginary components [symbol] , ℑ. One of the phase switches 444 is also used to phase shift the imaginary component by π/2 by application of a DC+NRZ signal as described with reference to FIG. 4c. A Y-branch 211 or 2×1 MMI 212 (not shown) acts as the combiner 410 to add the real and imaginary components [symbol] , ℑ.

The encoder 415 of FIG. 4f shows the use of DIMLs 253 as intensity modulators 455, 456 to encode the absolute or modulus of both real and imaginary components of a complex number β, ℑ. Electro absorption phase shifters 243 are used as phase switches 445, 446 to encode the polarity (or sign) of the real and imaginary components β, ℑ. A delay line 222 is used as a phase shifter 421 to phase shift the imaginary component by π/2. A Y-branch 211 or 2×1 MMI 212 (not shown) acts as the combiner 410 to add the real and imaginary components β, ℑ.

Similarly, the encoder 416 of FIG. 4g shows the use of DIMLs 253 as intensity modulators 455, 456 to encode the absolute or modulus of both real and imaginary components of a complex number β, ℑ. Electro absorption phase shifters 243 are used as phase switches 445, 447 to encode the polarity (or sign) of the real and imaginary components β, ℑ. One of the phase shifters 447 is also used to phase shift the imaginary component by π/2 by application of a DC+NRZ signal as described with reference to FIG. 4c. A Y-branch 211 or 2×1 MMI 212 (not shown) acts as the combiner 410 to add the real and imaginary components [symbol] , ℑ.

For both FIGS. 4f and 4g, the DIMLs are phase locked to another master laser (not shown) to lock the phase of the DIMLs to that of the master laser. This way the phase of the light in both arms encoding the real and imaginary terms are identical.

### Encoding Signed Real or Imaginary Components of a Complex Number Using Photonics

It can be useful to encode only a part (i.e. component) of a complex number. For example, the real and imaginary components of the complex number can be independently encoded. This can be useful for performing mathematical operations on a complex number because operations can be performed on components of the complex number independently.

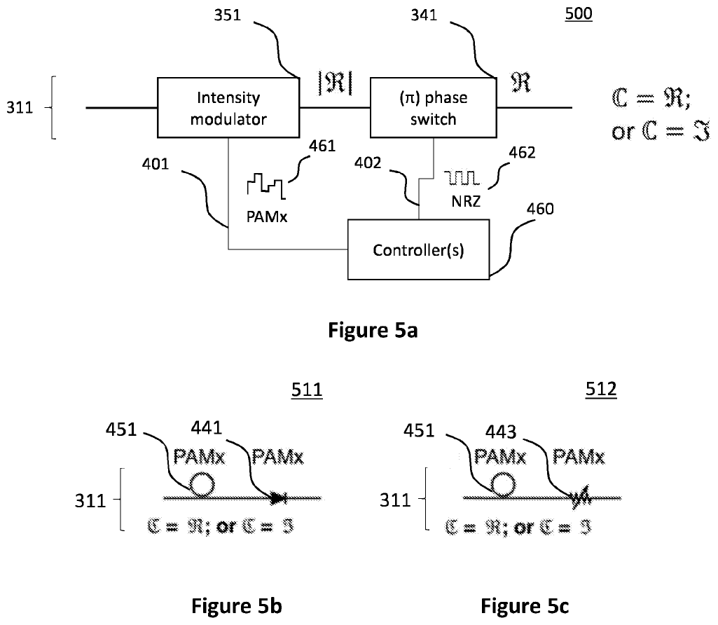

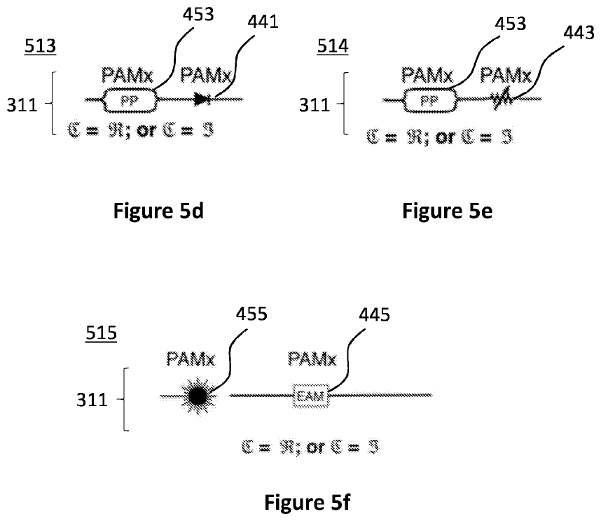

FIG. 5a shows an encoder 500 which is the same in structure, function and operation as the first series branch 311 of the system shown in FIG. 4a. The encoder 500 of FIG. 5a is configured to encode the absolute value and sign of either the real or imaginary component [symbol] , ℑ of a complex number [symbol] onto the first input signal 331. The encoder 500 shown in FIG. 5a includes the first intensity modulator 351 and first phase switch 341 arranged in series as described with reference to FIG. 4a. The encoder 500 also includes the controller 460 arranged to receive the first and second digital electronic signal and apply the first electronic signal 461 and second electronic signal 462 to the first intensity modulator 351 and first phase switch 341, respectively, as described with reference to FIG. 4a.

The encoders 511, 512, 513, 514, 515 shown in FIGS. 5b-5f are examples of the encoder 500 of FIG. 5a. Each of the encoders 511, 512, 513, 514, 515 of FIGS. 5b-5f is configured to perform the first and second steps S301, S302 as described with reference to FIG. 3a. Each of the encoders 511, 512, 513, 514, 515 of FIGS. 5b-5f can be connected to a controller 460 so as to supply the optical (photonic) components with electronic signals in the same way as described with reference to FIGS. 4a and 5a.

FIG. 5b shows an encoder 511 including an intensity modulator 451, specifically an MRR 251, configured to encode the absolute value or modulus of a real or imaginary component of a complex number z,63 , ℑ; the MRR 251 connected in series with a carrier depletion phase shifter 242 used as a phase switch 441 to encode the polarity (or sign) of the real or imaginary component [symbol] , ℑ.

FIG. 5c shows an encoder 512 including an intensity modulator 451, specifically an MRR 251, configured to encode the absolute value or modulus of a real or imaginary component of a complex number [symbol] , ℑ; the MRR 251 connected in series with a thermal phase shifter 241 used as a phase switch 443 to encode the polarity (or sign) of the real or imaginary component [symbol] , ℑ.

FIG. 5d shows an encoder 513 including an intensity modulator 453, specifically an MZI 252, configured to encode the absolute value or modulus of a real or imaginary component of a complex number [symbol] , ℑ; the MZI 252 connected in series with a carrier depletion phase shifter 242 used as a phase switch 441 to encode the polarity (or sign) of the real or imaginary component [symbol] , ℑ.

FIG. 5e shows an encoder 514 including an intensity modulator 453, specifically an MZI 252, configured to the encode absolute value or modulus of a real or imaginary component of a complex number [symbol] , ℑ; the MZI 252 connected in series with a thermal phase shifter 241 used as a phase switch 443 to encode the polarity (or sign) of the real or imaginary component [symbol] , ℑ.

FIG. 5f shows an encoder 515 including an intensity modulator 455, specifically a DIML 253, to encode the absolute value or modulus of a real or imaginary component of a complex number [symbol] , ℑ; the DIML 253 connected in series with an electro absorption phase shifter 243 used as a phase switch 445 to encode the polarity (or sign) of the real or imaginary component [symbol] , ℑ.

### Encoding Unsigned Real or Imaginary Components of a Complex Number Using Photonics

Although FIGS. 5a-5f show encoders arranged to encode real or imaginary components of a complex number [symbol] , ℑ including the polarity or sign thereof, it is possible to encode an unsigned real or imaginary component z,63 , ℑ by encoding the absolute value of the component using an intensity modulator 250 only (without a phase shifter and/or phase switch 220, 240). Suitable intensity modulators 250 are shown in FIGS. 5b-5f and include MRRs 251, MZIs 252 operating in push pull mode, DIMLs 253 including surface emitting DIMLs such as vertical cavity surface emitting lasers, microdisk lasers, distributed feedback lasers, or lasers with multi-section sampled grating distributed Bragg reflectors.

### Encoding Complex Mathematical Numbers in Polar Coordinates Using Photonics

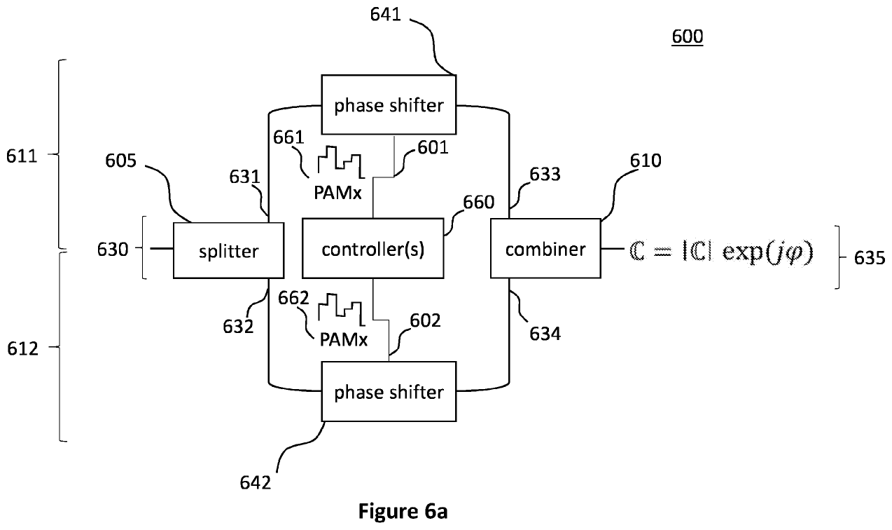

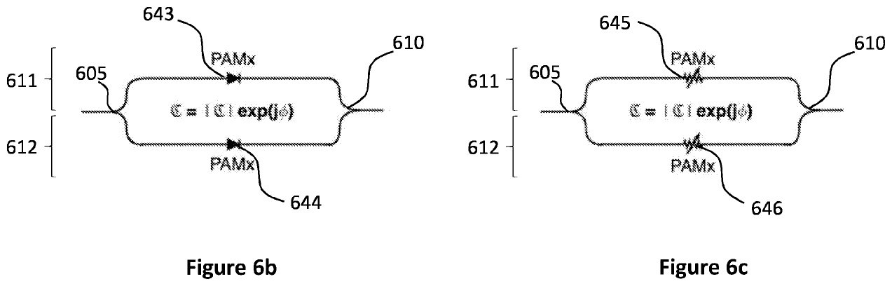

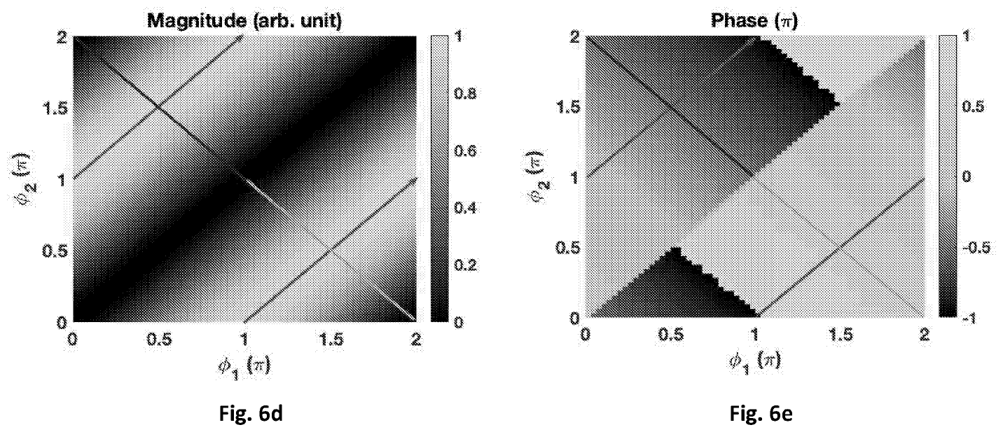

A complex number represented in polar coordinates can be encoded in the optical domain by modulating the magnitude and phase of an input signal simultaneously while exploiting the physics of the encoding circuit. FIG. 6a is a schematic showing an encoder 600 configured to encode a complex number [symbol] in this manner. The encoder 600 includes a controller 660 arranged to provide electronic signals 661, 662 to optical (photonic) components of the encoder 600 to encode a complex number [symbol] in polar form onto an optical input signal. The electronic signals are based on digital signals carrying data representing components of the complex number [symbol] .

The optical part of the encoder 600 is in the form of an MZI in which a first phase shifter 641 is included in a first branch 611 thereof and a second phase shifter 642 is included in the second branch 612 thereof. An input channel 630 is operatively connected to a splitter 605, which is in turn operatively connected to input ends of the first and second branches 631, 632 of the MZI 252. Output ends of the first and second branches 633, 634 are operatively connected to a combiner 610, and the combiner 610 is operatively connected to an output line 635. The controller 660 is connected to the first phase shifter 641 via at least one first line 601, and to the second phase shifter 642 via at least one second line 602.

In operation, an optical input signal is provided through the input channel 630, which input channel is split by the splitter 605 into the first and second branches 631, 632 of the MZI 252. The controller 660 supplies at least one first electronic signal 661 via the at least one first line 601 to the first phase shifter 641; and at least one second electronic signal 662 via the at least one second line 602 to the second phase shifter 642. The at least one first electronic signal and second electronic signal are respectively based on at least one value of a first and second digital electronic signal received by the controller. The digital data received by the controller is calibrated against (or obtained from) a digital look up table. The digital lookup table contains data words required for precise encoding of a complex number, more specifically the phase and magnitude encoding in polar co-ordinates. This way the controller accurately supplies necessary first and second electronic signals to the phase shifters to accurately represent a given complex number. The first and second phase shifters 641, 642 introduce independent phase shifts to the first and second branches 611, 612 of the MZI 252, for example by each exploiting plasma dispersion effects, Franz-Keldysh effects, electro-absorption effects; or thermal effects. The outputs from the first and second branches 633, 634 are then combined by the combiner 610 (a Y-branch 211 or 2×1 MMI 212) to provide an optical signal encoded with the complex number [symbol] represented in polar form, i.e. in the form of equation 1b.

In more detail, the amplitude and phase of the photonic signal at the combiner 610 is controlled by controlling the phase shifts (ϕ₁), (ϕ₂) at the first and second phase shifters 641, 642 relative to the phase at the splitter 605. FIG. 6d and FIG. 6e show graphs of the normalised intensity (magnitude) change and phase at the combiner 610, relative to the input optical signal, as a function of independent relative phase shifts (ϕ₁), (ϕ₂) at the first phase shifter 641 and second phase shifter 642 respectively. These information represented by these graphs may alternatively take the form of a look up table. The electronic signals 661 and 662 driving the first and second phase shifters 641 and 642 are so supplied such that the phase in each branch of the MZI is modulated to cause the intensity and phase of the photonic signal at the combiner 610 to form an accurate photonic representation of the respective mathematical equivalent of the complex number encoded onto the digital electronic signals received at the controller (and the resultant electronic signals supplied to the phase shifters). A lookup table takes into cognisance the phase shifts (ϕ₁), (ϕ₂) at the first and second phase shifters 641, 642 as a function of voltage or current for the photonic device and the controller supplies an electronic signal sufficient to provide the phase shift required at the first and second phase shifters 641 and 642.

More particularly, a first lookup table (or function or graph) contains a master data of phase and magnitude (of the output signal at the combiner 610) as a function of phase perturbation in both arms of the MZI. A native digital data (complex number—magnitude and argument) is checked against the first look up table or equivalent phase and magnitude graphs of FIGS. 6d and 6e to ascertain the phase perturbation required in MZI arms 1 & 2 respectively. Then a second lookup table (or a function or graph), which contains the voltage and/or current data necessary for driving the phase shifters to apply the necessary phase shifts, is used to fetch the exact digital data used by the controllers for analog conversion and subsequently sending the electronic signals to the phase shifters to encode the complex number onto the optical input signal.

In the encoder 600 of FIG. 6a, the first and second electronic signals 661, 662 are both PAMx signals, wherein x is greater than 2 (in other words, the first and second electronic signals 661, 662 are multi-bit signals).

FIGS. 6b and 6c show examples of the encoder 600 described with reference to FIG. 6a, wherein the splitter 605 and combiner 610 are both Y-branches 211. In FIG. 6b, the phase shifters 643, 644 are both carrier depletion phase shifters 242 and in FIG. 6c, the phase shifters 645, 646 are both thermal phase shifters 241.

In an alternative arrangement described with reference to FIG. 6a, a complex number [symbol] represented in polar coordinates can be encoded in the optical domain by modulating the magnitude and phase of an input optical signal separately in a single series branch, thereby effectively multiplying the magnitude and phase values. Such a method can be carried out using the system of FIGS. 5a to 5f, but with a phase shifter instead of the phase switch, wherein the second electronic signal 462 is (or is based on) a PAMx signal with x greater than 2 (i.e. a multi-bit signal) so that a range of argument values can be encoded onto the optical input signal. That is, the photonic devices are modulated based on a multi-bit signal (such as PAMx, where x=2^{N} and N is the bit precision of the system).

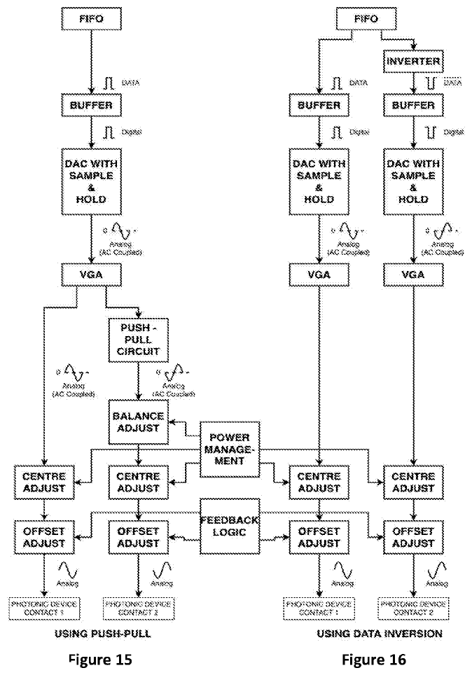

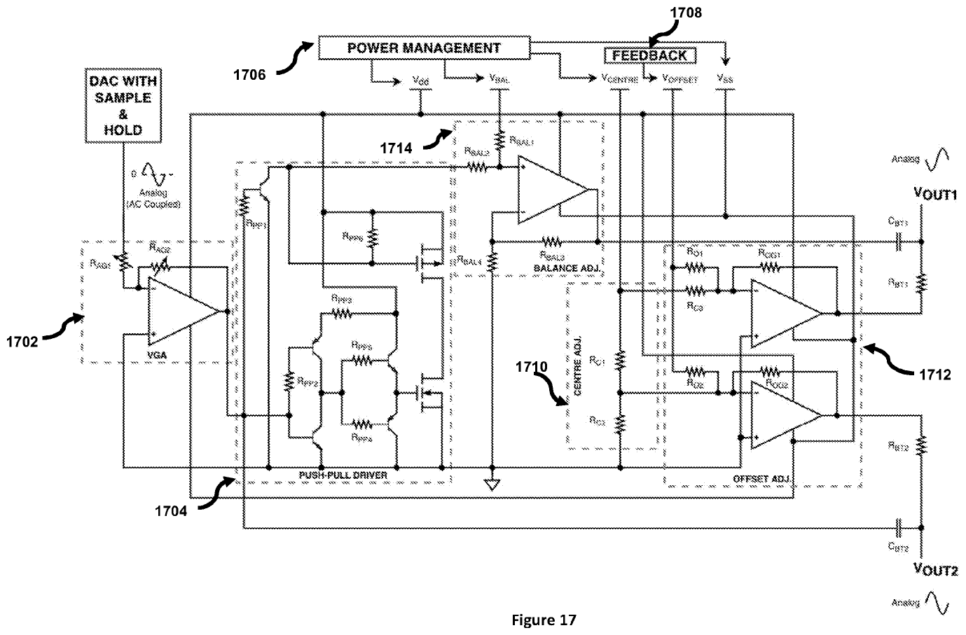

The controller described with reference to FIGS. 4a-4g, 5a-5f and 6a-6c may include a plurality of sub-controllers so that each modulator receives a signal from a separate sub-controller. Each sub-controller is arranged to receive a digital electronic signal and control the modulator based on a value of the digital electronic signal so that the modulator applies the respective element of modulation operable to encode the complex element onto the optical signal. Examples of such sub-controllers are described with reference to FIG. 15, FIG. 16 and FIG. 17.

Encoding in these ways allows an improved (e.g. more efficient, more streamlined) digital data input and rapid/efficient encoding of the input streams/optical signals with complex elements. A photonic integrated circuit employing encoders as described above is better suited to interfacing with external electronic components, for example a computer processor or memory.

### Performing Mathematical Operations on Complex Numbers Encoded onto Optical Signals

There is provided a method of performing mathematical operations (e.g. arithmetic) on complex mathematical numbers using photonics.

### Multiplication of Complex Mathematical Numbers

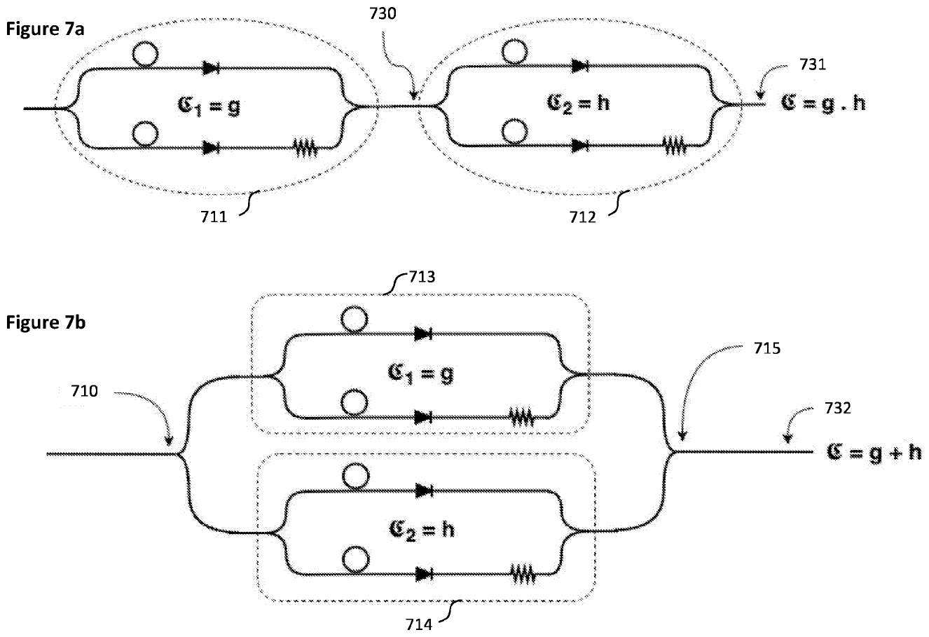

Multiplication of complex elements (complex numbers or components of complex numbers) can be performed by cascading encoders that represent each of the multiplicands successively in series. For example, FIG. 7a shows a first encoder 711 and a second encoder 712 connected in series, such that the optical output signal from the first encoder 711 forms the input to the second encoder 712. The first and second encoders 711, 712 can be any of the encoders described in the present disclosure. In FIG. 7a, the first and second encoder 711, 712 each take the form of the encoder described with reference to FIG. 4b. In FIG. 7a, the first encoder 711 is configured to encode a first complex number [symbol] ₁=g onto an optical input signal to provide a first encoded optical signal. The second encoder 712 is configured to encode a second complex number [symbol] ₂=h onto an optical signal to provide a second encoded optical signal. The output of the first encoder 711 is connected via a connecting branch 730 to the input of the second encoder 712 so that the optical signal input into the second encoder 712 is encoded with the first complex number [symbol] ₁. The optical output signal 731 from the second encoder 712 is then encoded with a third complex number [symbol] =g. h being the multiple of the first and second complex numbers [symbol] ₁, [symbol] ₂. Using the principle of FIG. 7a, it is also possible to multiply a first complex element by a second complex element by feeding an optical signal already encoded with the first complex element (by whatever means e.g. via the output of an OFT stage) into the input of an encoder configured to encode the second complex number.

### Addition of Complex Mathematical Numbers

Addition of complex elements can be performed by placing encoders that represent each of the multiplicands in parallel. For example, FIG. 7b shows a first encoder 713 and a second encoder 714 connected in parallel. An optical input signal is input to a Y-branch which acts as a splitter 710 to provide the optical input to the first encoder 713 and an identical optical input to the second encoder 714. The first and second encoders 713, 714 can be any of the encoders described in the present disclosure. In FIG. 7b, the first and second encoders 713, 714 each take the form of the encoder described with reference to FIG. 4b. In FIG. 7b, the first encoder 713 is configured to encode a first complex number [symbol] ₁=g onto an optical input signal to provide a first encoded optical signal. The second encoder 714 is configured to encode a second complex number [symbol] ₂=h onto an optical signal to provide a second encoded optical signal. A Y-branch 211 acts as a combiner 715 which combines the output of the first encoder 713 with the output of the second encoder 714 so that the optical output signal 732 output from the combiner 715 encoded with a third complex number [symbol] =g+h being the sum of the first and second complex numbers [symbol] ₁, [symbol] ₂. Using the principle of FIG. 7b, it is also possible to add a first complex element and a second complex element by feeding an optical signal already encoded with the first complex element (by whatever means) and an optical signal already encoded with the second complex element (by whatever means) into a combiner.

### Detecting Complex Mathematical Number Using Photonics

There is provided a method of detecting a complex mathematical number, or a component of the complex mathematical number, from characteristics of an optical signal that has been previously encoded with a complex number (or component of a complex number) by any of the methods and apparatuses described herein. This can include detecting a second complex mathematical number, or a component of thereof, from the properties of an optical signal that has been previously encoded with a first complex number (or component thereof) and modified to perform a mathematical (e.g. arithmetic, OFT or convolution) operation on the first complex number to produce the second complex number.

Decoding the Absolute Value or Modulus of a Complex Mathematical Number Encoded onto an Optical Signal

An intensity detector such as a photodiode can be used to natively detect the absolute value or modulus of a complex mathematical number encoded onto an optical signal by detecting the amplitude of the optical signal.

### Decoding a Real or Imaginary Component of a Complex Number

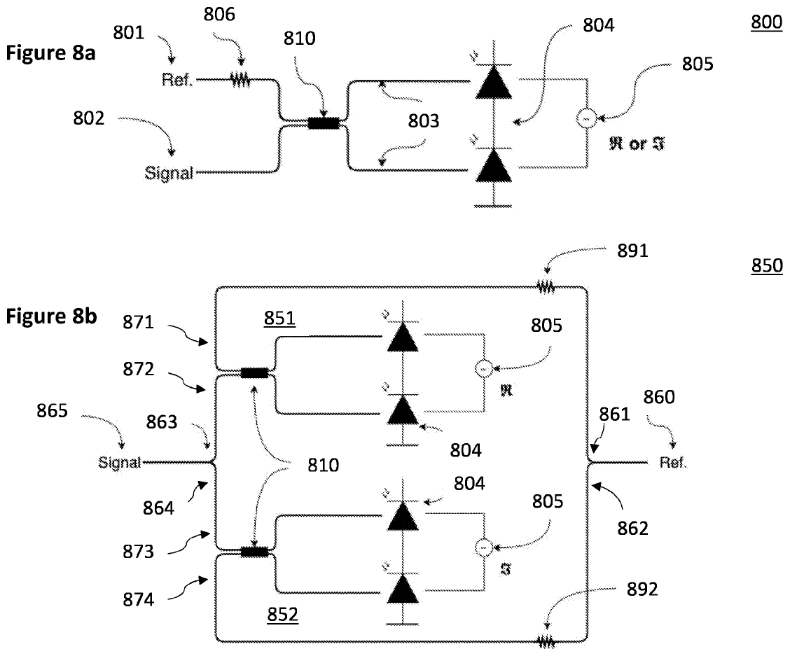

Homodyne detection using balanced detectors can be used to natively decode real or imaginary numbers (that is, the real or imaginary component of a complex number including its modulus and sign) which have been encoded onto an optical signal. A schematic of a balanced detector 800 configured to decode in this way is shown in FIG. 8a. The balanced detector 800 comprises a first input branch comprising a reference line 801 having a reference input and a second input branch comprising a signal line 802 having a signal input coupled to the input of an interferometer 810, specifically a 2×2 MMI. The interferometer has two output branches 803, each output branch having a photodetector 804 included therein, specifically two balanced photodetectors are connected to receive the outputs 803 from the interferometer 810. The output 805 from the balanced photodetectors 804 is the difference in photocurrents from each of the constituent photodetectors that form the balanced photodetector. The reference line includes a (e.g. variable) phase shifter 806. The reference line is arranged to receive a signal based on the input optical signal to the encoder as a source.

A full complex number can be decoded from an optical signal by performing two detections (or measurements) using balanced detector—one to decode the real part of the complex number and another to decode the imaginary part; by suitably adjusting a phase shifter 806 (e.g. a thermal heater or a delay line). The real part of the complex number is decoded from the optical signal by selecting the reference input to the balanced detector to be in phase with the light used to encode the real part. The imaginary part of the complex number is decoded if the phase of the reference input to the balanced detector is selected to be in phase with the light used to encode the imaginary part. The full complex number in cartesian coordinate (cartesian form) is recovered by adding the decoded real and imaginary parts. For a polar co-ordinate, the magnitude and argument are calculated digitally from the real and imaginary terms using equations 3a and 3b, respectively.

$$\vert \vert = {( {2}^{} + {2}^{} )}^{0.5} \qquad ( equation 3 a )$$

$$φ = arctan ( / ) \qquad ( equation 3 b )$$

Decoding a Complex Mathematical Number Encoded onto an Optical Signal

Two balanced detectors and a π/2 (90 degree) optical hybrid can be used to natively detect a complex number encoded onto an optical signal. FIG. 8b shows such an arrangement. In FIG. 8b, a decoder circuit 850 comprises a first balanced detector 851 configured to decode the real part of the complex number and a second balanced detector 852 configured to decode the imaginary part of the complex number. The first and second balanced detectors 851, 852 are each substantially the same in structure, function and operation as the balanced detector 800 described with reference to FIG. 8a.

FIG. 8b shows a reference branch 860 split into a first input branch 861 and a second input branch 862 and a signal branch 865 split into a third input branch 863 and a fourth input branch 864. The first and third input branches 861, 863 respectively serve as the reference and signal inputs 871, 872 to the first balanced detector 851. The second and fourth branches 862, 864 respectively serve as the reference and signal inputs 873, 874 to the second balanced detector 852. The first input branch 861 includes a first phase shifter 891 and the second input branch 862 includes a second phase shifter 892.

In operation, the encoded optical signal (encoded with a full complex number) is input to the signal branch 865 while a reference input signal is simultaneously input into the reference branch 860. The reference input signals 861 and 862 are selected to be in phase with the light used to encode the real and imaginary part, respectively, of the complex number when the complex number was encoded onto the optical signal. The first and second phase shifters 891, 892 allow the phase of the reference input signals 861 and 862 to be adjusted in the first input branch 861 and second input branch 862, respectively. The first phase shifter 891 is configured to cause the signal in the first input branch 861 to be in phase with the light encoded with the real part of the complex number. For example, if the encoder 300 described with reference to FIG. 4a was used to encode the complex number, the first reference in the first input branch 861 in the decoder circuit 850 of FIG. 8b would be selected to be the same as the signal in the first series branch 311 of the encoder 300 of FIG. 4a, while the second phase shifter 892 would be configured to cause the reference in the second input branch 862 to be in phase with the signal in the second series branch 312 after the phase shift providing orthogonality (i.e. step S305).

In other words, the 90 degree optical hybrid splits the reference input signal into two. The imaginary part of the encoded complex number is recovered from the encoded optical signal using the second balanced detector 852 where the phase of the reference input signal is shifted by π/2 to be in phase with the light used to encode the imaginary part. The real part of the encoded complex number is recovered from the encoded optical signal using the first balanced detector 851 where the phase of the reference input signal remains unchanged.

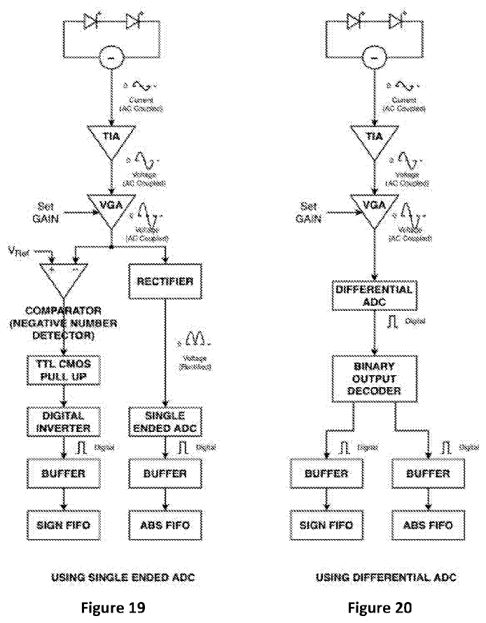

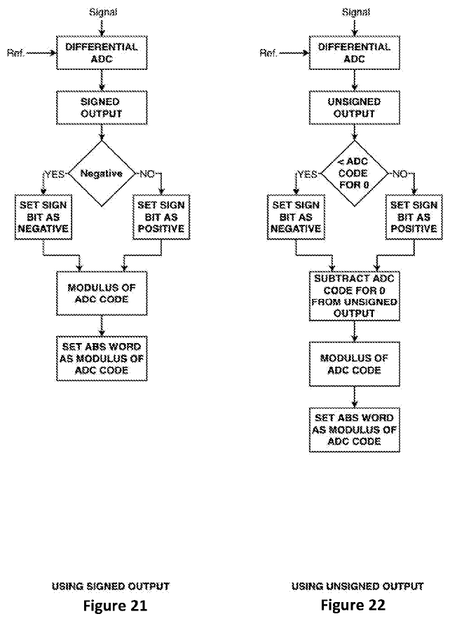

Details of electronic decoder circuits connected to the balanced detectors shown in FIGS. 8a and 8b are described with reference to FIG. 19, FIG. 20, FIG. 21 and FIG. 22. Such electronic decoder circuits transform the optical signal received at the photodetectors into a digital electronic signal carrying the complex elements encoded onto the optical signal.

Once the real and imaginary parts of the complex number have been decoded, the full complex number is recovered by adding the decoded real and imaginary parts.

In more general terms, there is provided a decoder arranged to: produce a first difference signal based on an output stream of an optical Fourier transform stage and a first reference stream, and produce a second difference signal based on the output stream and a second reference stream. The output stream is encoded with a full complex number (e.g. the aforementioned second complex element). The decoder is also arranged to detect at least one first characteristic of the first difference signal, detect at least one second characteristic of the second difference signal, output a first digital electronic signal encoded with a first component of the second complex element based on the at least one first characteristic, and output a second digital electronic signal encoded with a second component of the full complex number based on the at least one second characteristic. The at least one characteristic may be phase and/or amplitude.

The decoder comprises at least one balanced detector, for example a first and a second balanced detector. The first balanced detector is configured to receive the output stream and the first reference stream, and the second balanced detector is configured to receive the output stream and the second reference stream. The phase difference between the first reference stream and the second reference stream is nπ/2, where n is an odd integer.

The first digital signal is a first segment of a digital word, the first segment representing the real component of the full complex number, and the second digital signal is a second segment of the digital word, the second segment representing the imaginary component of the full complex number, wherein the digital word represents the full complex number.

Decoding in this way provides an improved digital data output and rapid/efficient decoding of the output stream. A photonic integrated circuit employing a decoder of this kind is better suited to interfacing with external electronic components, for example a computer processor or memory.

### II—Optical Apparatus (Photonic Integrated Circuit)

### Basic Optical Fourier Transform Stages

FIGS. 9a-9d show features of optical Fourier transform stages.

FIG. 9a shows a schematic of a 2f stage 900. The 2f stage includes transparent free-space optical block (hereinafter ‘optical block’) 901 housing a Fourier lens 902. The Fourier lens is positioned 1 focal length f from each of an input end 903 and output end 904 end of the optical block 901. Light entering the input end 903 undergoes an optical Fourier transform when it passes through the Fourier lens 902. Therefore, the light at the output end 904 of the optical block is a Fourier transform of the light entering the input end 903.

FIG. 9b shows a schematic of the 2f stage 900 of FIG. 9a including an array of input waveguides through which streams of light (i.e. optical signals) travel and enter the optical block 901 upon exiting the input waveguides. The light is coupled into the optical block through fibre; through the use of grating couplers; or any other method of out coupling of light from a waveguide. Output waveguides collect the optical output of the 2f stage at the output plane of the Fourier lens. In this case, the optical block 901 has prismatic ends at the input end and output end so that the light enters the transparent block initially orthogonal to the optical axis of the Fourier lens and the optical path is bent 90 degrees by internal reflection form the surface of the prismatic end to travel through the Fourier lens 902. The output end of the optical block is formed in the same way so that light passing through the Fourier lens 902 is bent at 90 degrees toward the entry apertures of the output waveguide. Output streams of light are coupled into the output waveguides.

As shown in FIG. 9c, input ports 905 and output ports 906 (i.e. exit apertures of the input waveguides and entry apertures of the output waveguides, respectively) can be arranged in a 2D array or 1D array. The term ‘input port’ refers to the terminal of a waveguide arranged at the beginning of the 2f stage so that input streams of light exiting the waveguides enter the 2f stage. The term ‘output port’ refers to a terminal of a waveguide arranged at the end of the 2f stage so that light exiting the 2f stage enters the waveguides as output streams of light.

For the integrated OFT device of FIG. 9d, beam quality is irrelevant because it is a guide mode device. For the 2f stage of FIG. 9b, the optical block may have corrective optics, for e.g. micro lens array for each input or output port, to ensure that the beam quality is such that it enables efficient coupling back into the receiving waveguides!

Examples of 2f stage arrangements using 1 dimensional arrays of waveguides are provided in C. Dragone, ‘Efficient N*N star couplers using Fourier optics’, J. Light. Technol., vol. 7, no. 3, pp. 479-489, March 1989, doi: 10.1109/50.16884. FIG. 9d shows a 2f stage of the OFTC type having a 1D array of input ports and a 1D array of output ports. In such devices the input ports 905 and output ports 906 are positioned along the circumference of two confocal circles, the radius of which depends on the number of input and output waveguides.

### Optical Fourier Transform Stages Including Encoders and Decoders

In general terms, an optical apparatus according to an embodiment includes: a plurality of encoders, each encoder arranged to encode a first complex element onto an input stream of light; and a plurality of input ports arranged in a first array. Each input port is arranged to be supplied with a corresponding one of the input streams, thereby forming an input function definable based on the value of the first complex elements and the position of the corresponding input ports in the first array. The input ports are arranged to provide an optical input to an optical Fourier transform stage arranged to perform at least one optical Fourier transform or convolution of the input function. The optical apparatus further includes: a plurality of output ports arranged in a second array, each output port arranged to receive a portion of the output of the optical Fourier transform stage and thereby form an output stream. The optical apparatus also includes a plurality of decoders, each decoder arranged to decode a second complex element from each of the output streams based on at least one characteristic of the respective output stream.

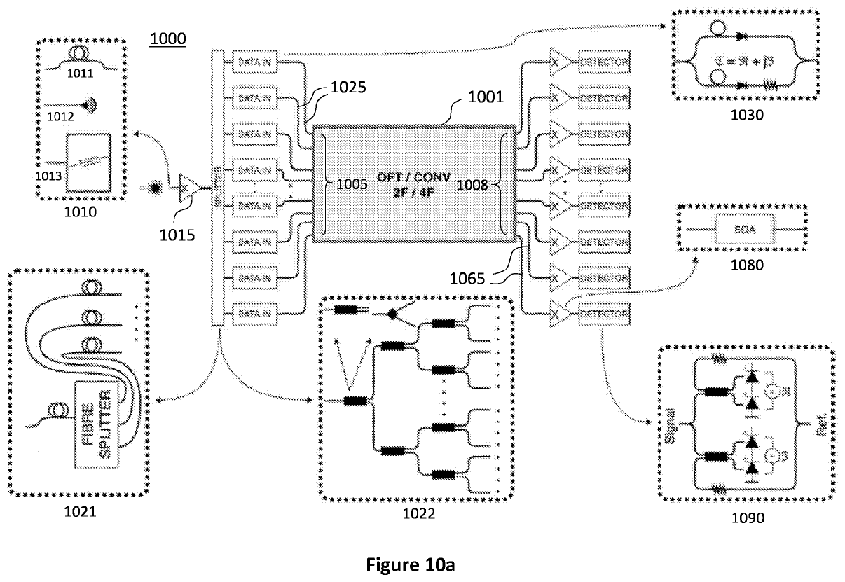

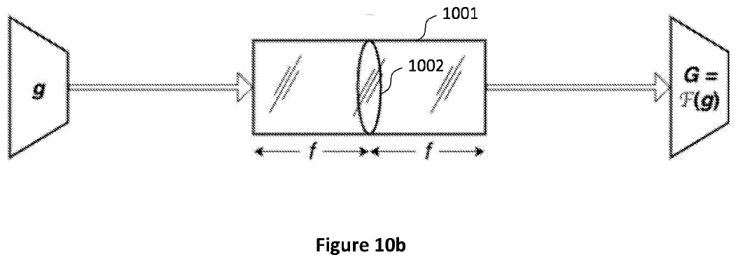

FIG. 10a is a schematic of a more specific example of such an optical apparatus. The optical apparatus 1000 of FIG. 10a is built around an optical Fourier transform stage 1000 which includes either a 2 focal length (2f stage) or a four focal length (4f stage) Fourier optics arrangement, the 4f stage arrangement comprising a first and second 2f stage. Each 2f stage may take the form of FIG. 9b (2D arrays of input and output ports) or FIG. 9d (an OFTC with 1D arrays of input and output ports) The optical apparatus can be described as photonic circuit (or photonic integrated circuit PIC) and may be included as part of a hybrid computer chip including both electronic and optical components.

In general terms, the optical apparatus includes a light source arranged to provide coherent light and a splitter arranged to split the coherent light into a plurality of input streams. In embodiments, the light source is a laser source, for example a solid-state semiconductor laser. However, embodiments are not limited to a laser source and other coherent light sources are also envisaged. The optical apparatus is wavelength independent, but the use of a monochromatic light for each Fourier transform ensures fidelity of the optical Fourier transform. Broadband sources can be used if filtering methods are employed for each Fourier transform.

In the optical apparatus (or PIC) of FIG. 10a, a solid-state semiconductor laser source 1010 provides the coherent light. The laser can be housed off-chip, in which case the light is coupled into the PIC (i.e, the rest of the optical apparatus) using a fibre 1011 and coupling said fibre via grating couplers 1012, or edge couplers using ferrules 1013, or V-shaped grooves. Alternatively, the light (e.g. laser) source 1010 can be packaged in the same carrier substrate with the PIC and light coupled into the PIC through edge couplers and photonic wire bonds. Alternatively, the light (e.g. laser) source 1010 can be integrated with the PIC and light coupled into the PIC through edge couplers and tapers with or without photonic wire bonds.

In the optical apparatus of FIG. 10a, the input coherent light from the light source 1010 is amplified using an optical amplifier 1015 before being split into a plurality of input waveguides 1025. This is achieved by either splitting coherent light from the laser off-chip and coupling in laser light to fibre bundles using a fibre splitter 1021, or by coupling in the laser light to a single fiber initially, and splitting the light using cascaded MMIs or Y-branches 1022. The input waveguides 1025 are channels for the input streams, and can include, for example, optical fibres or any other optical conduits. If using cascaded MMIs or Y-branches 1022, the input streams stem from the output of the last stacked or cascaded 1×2 splitters. The input waveguides 1025 carry the input streams of light split from the source to the input ports 1005 arranged in the first array.

FIG. 10a shows a plurality of optical encoders 1030 (also referred to herein as photonic devices), each optical encoder 1030 arranged in the path of a corresponding one of the input streams. The optical encoders 1030 are arranged to encode the first complex element onto the corresponding input streams. The optical encoder 1030 of the type shown in FIG. 4b is shown in FIG. 10a as an example and therefore a full complex number in cartesian form is encoded onto each of the input streams. However, the optical encoders 1030 can include any of the encoders described with reference to FIGS. 3a, 3b, 4a-g, 5a-f, or 6a-c. The optical encoders 1030 encode complex elements (e.g. complex mathematical numbers, or components of complex mathematical numbers) onto the input streams of light before the input streams enter the optical Fourier transform stage 1001. Optionally, the input streams may pass through optical circuits, each optical circuit including at least the optical encoder 1030 and optionally further optical encoders. The optical circuits act on each input stream of light prior to entry into the optical Fourier transform stage. An application of such optical circuits is described herein.

The input streams (and later output streams and intermediate streams) described herein may be described as streams of light, or optical signals. In embodiments, the streams are carried by the waveguides. The term “waveguide” when used herein refers to an optical (i.e. photonic) waveguide such as an optical fibre. The light in the streams is monochromatic and coherent both within each input stream and between input streams.

The value of the first complex element encoded onto each of the input streams can differ between input streams so that the value of the input function varies with the positions of the input ports in the first array due to the variations in the input function in x-and/or y-directions.

Two variables can be used to define or approximate each of the input and output functions: (i) the relative position (e.g. an x-y position) of the ports within the array; and (ii) the value of the complex number encoded onto the streams of light passing through (e.g. entering or exiting) the ports. It may therefore be understood that the input and output functions are each sampled versions of a continuous function, wherein the sampling resolution is determined by the aperture size of the ports and/or the port spacing or pitch.

Temporal variation in the input streams can also be applied by varying the value of the first complex element encoded onto each input stream over time. The input streams may be continuous (always on, or on for multiple cycles of a clock signal). Alternatively, the input streams may also be pulsed (intermittently on and off, optionally in sync with a clock signal). The value of the first complex elements encoded onto the input streams may change with each clock cycle so that multiple optical Fourier transforms can be carried out consecutively, frame-by-frame.

The waveguide carrying an individual input stream may split and recombine in various ways depending on the type of encoder used to encode the first complex element and, as will be described in more detail herein, the type of optical circuit used to perform an arithmetic operation on the first complex element.

The outcoupling from the waveguides to the optical Fourier transform stage (i.e. the OFTC or the free-space optical element, depending on the type of OFT stage) and vice versa may be performed using grating coupler devices or alternatively using fibre bundles coupled to the OFT stage using edge couplers.

The first array of input ports is now described in more detail, however this description can also apply to the second array of output ports, as well as the third array of intermediate output ports and fourth array of intermediate input ports described herein. The terms ‘array’ and “port” are temporarily used as a generic stand-in for the aforementioned features.

The ports may be described as pixels and the waveguides carrying the respective streams may be referred to as ‘channels’. In embodiments, the arrays of ports described herein are 1D or 2D arrays. The array may be arranged on a straight line (1D), a flat plane (2D), a curved line (1D) or other type of spline (1D), or a curved surface (2D) or other type of surface (2D), depending on the type of optical Fourier transform stage used. For example, typically, though not always, the array is a 1D array arranged on a curved line when the optical Fourier transform is carried out using an integrated OFTC device. Conversely, if using a free-space optical Fourier transform stage with a Fourier transform lens, the array may be arranged on a flat plane facing the Fourier transform lens. The array may take the form of a 1D or 2D pattern, such as a regular rectangular array comprising regular rows of ports and orthogonal columns of ports, or a staggered array in which adjacent columns of ports are offset from one another in the direction of the columns, so that rows of ports are formed in a direction oblique to the direction of the columns.

The arrays face the Fourier transform lens so that the input ports are arranged to illuminate the Fourier transform lens and the output ports are arranged to collect light which has passed through the Fourier transform lens. The input ports are arranged one focal length behind the Fourier transform lens and the output ports are arranged one focal length in front of the Fourier transform lens. It may be understood that the input ports are arranged to provide the optical input to the optical Fourier transform stage and the output ports are arranged to sample the optical output of the optical Fourier transform stage. The optical Fourier transform stage performs an optical Fourier transform of the optical input to provide the optical output.

Returning to FIG. 10a, the optical apparatus includes an array of output ports 1008, each output port being connected via an output waveguide 1065 to an optical amplifier 1080 and then on to a detector (or decoder) 1090. Each optical amplifier 1080 is arranged to amplify the respective output stream. In FIG. 10a, the optical amplifiers 1080 are semiconductor optical amplifiers (SOAs). However, embodiments are not limited thereto and other types of optical amplifier may be used. Alternatively, no optical amplifiers are used.

The detector (or decoder) 1090 is arranged to detect (or decode) the second complex element encoded onto each output stream collected by the output ports 1008. In FIG. 10a the decoder shown in FIG. 8b is given as an example, in which the decoders make use of two balanced detectors with a 90 degree optical hybrid to detect a full complex number from the output streams. However, each of the decoders 1090 can include any of the decoders described with reference to FIG. 8a or 8b or other types of decoder arranged to decode complex elements from optical signals. The decoders may include one or more of the circuits described with reference to FIG. 19, FIG. 20, FIG. 21 and FIG. 22.

The decoder 1090 is arranged to decode a second complex element from each of the output streams based on at least one characteristic of the respective output stream. A value of the at least one characteristic is detected by the decoder and translated into a form which is representative of the second complex element. In embodiments, the at least one characteristic is a phase and/or amplitude of the output stream and the value of said phase and/or amplitude is equal to or correlates with the value of the second complex element. The phase may a phase relative to the phase of the input streams.

In another example, the optical Fourier transform stage comprises a single 2f stage (a two-focal-lengths OFT) which is used to calculate the OFT of an input function to obtain the Fourier transform of the input function as an output function. A complex mathematical function g is encoded onto the input streams. OFT of the input function is performed using an optical Fourier transform stage. The OFT light is recoupled back into the output ports and waveguides channelling the output streams for decoding. As with all of the 2f stages described herein, the OFT stage may include the free space optical module shown in FIGS. 9a and 9b, or the OFTC shown in FIG. 9d.

FIG. 10b shows an application of the optical apparatus of FIG. 10a. In FIG. 10b, first complex elements are encoded onto the input streams to create an input function g displayed in the first array at the input to the OFT stage 1001, which is a 2f stage. An optical Fourier transform is performed using the optical Fourier transform stage 1001 to produce an output function G=F(g) at the Fourier plane (where the output ports are located). The output function G=F(g) is the Fourier transform of the input function g. If the input function is itself a product of two Fourier transforms g=F(x)*F(y), then the output of the Fourier transform is the convolution of the input functions x and y.

### Mathematical Operations and Optical Fourier Transforms

The first complex elements encoded onto the input streams can be the subject of a mathematical operation before the input streams exit the input ports. For example, the first complex elements can be multiplied by an additional complex element or added to additional complex elements to cause third complex elements to be encoded onto the input streams, the third complex elements being the result of the mathematical operation. The mathematical operation can be carried out by using one or more encoders to encode complex elements onto the input streams. The one or more encoders can be said to form an optical circuit.

In general terms, the optical apparatus further comprises a plurality of first optical circuits, each first optical circuit arranged to act on a corresponding one of the input streams to perform an arithmetic operation on the corresponding encoded first complex element, thereby encoding the input streams with a third complex element. The input function is definable based on: the value of the third complex elements instead of the value of the first complex elements, and the position of the corresponding input ports in the first array.

In general terms, each first optical circuit is a multiplier circuit arranged to act on the input stream to multiply the first complex element with an additional complex element in order to encode the input stream with the third complex element. In other embodiments, each first optical circuit is an addition circuit arranged to act on the input stream to add an additional complex element to the first complex element in order to encode the input streams with the third complex element.

In embodiments, the optical circuits are any of the optical circuits described with reference to FIGS. 7a and 7b. For example, the multiplier circuit can be of the type described with reference to FIG. 7a, wherein the first encoder 711 is arranged to encode the first complex element, the second encoder 712 is arranged to encode the additional complex element and the output stream from the multiplier circuit is encoded with the third complex element, wherein the third complex element is the product of the first complex element and additional complex element. The addition circuit can be of the type described with reference to FIG. 7b, wherein the first encoder 713 is arranged to encode the first complex element, the second encoder 714 is arranged to encode the additional complex element and the output stream from the addition circuit is encoded with the third complex element, wherein the third complex element is the sum of the first complex element and additional complex element.

In general terms, in a first operating mode, the value of the additional complex element is such that the third complex element is equal to the first complex element. In a second operating mode, the value of the additional complex element is such that the third complex element is not equal to the first complex element.

The above first operating mode is achieved by setting the value of the additional complex element to be 1 (i.e. unity) in the multiplier circuit or zero in the addition circuit.

### 2f OFT Stage for Performing Convolutions

A single 2f optical Fourier transform stage (hereinafter ‘2f stage’) can be made to perform the same function as a 4f optical Fourier transform stage (i.e. a convolution) by performing two consecutive OFT operations as follows.

In a first operation, the 2f stage is set to the above described first operating mode. The additional complex element is set as described above for the first operating mode so that the input function to the 2f stage is defined by the values of the first complex elements in the first array. The 2f stage then performs an optical Fourier transform of the input function and outputs a first output function at the second array of output ports. The second complex elements are decoded from the output streams as described herein. An intermediate step of determining an output function from the output streams and the position of the corresponding output ports can then be performed.

In a second operation, the value of each of the additional complex elements applied in the optical circuits is set equal to be equal to the value of the second complex elements decoded from the output streams generated in the first operating mode. In other words, the output function is sampled in the first operating mode and then, in the second operating mode, the resulting output function is then fed back in to the optical circuit in the form of the additional complex elements. This can be implemented for each of the input streams by configuring an encoder to encode the additional complex element and applying this encoder in an optical circuit along with an encoder arranged to encode the first complex element. The result is that the optical circuits effectively multiply the first complex elements by the additional complex elements so that the input streams are encoded with the third complex elements.

Continuing in the second operating mode, the 2f stage performs another optical Fourier transform of the input function, which this time is defined by the values of the third complex elements and the corresponding position of the input ports in the array. The output function is then sampled in the second operating mode by decoding the complex elements from the output streams.

This method involving two consecutive measurements using the same 2f stage effectively provides the same result as one measurement using a 4f stage, where the additional complex element is applied in an optical circuit positioned between the two 2f stages which make up the 4f stage. A description of such a 4f stage now follows.

### 4f OFT Stage for Performing Convolutions

In general terms, the aforementioned optical Fourier transform stage is a 4f stage comprising a first 2f stage and a second 2f stage. The input ports are arranged to provide the optical input as an input to the first 2f stage, and each of the output ports is arranged to receive a portion of the output of the second 2f stage as the previously described portion of the output of the optical Fourier transform stage.

Therefore, the previously described input ports to the optical Fourier transform stage are part of the first 2f stage and the previously described output ports of the optical Fourier transform stage are part of the second 2f stage.

Continuing in general terms, the 4f stage further comprises: a plurality of intermediate output ports arranged in a third array. Each intermediate output port is arranged to receive a portion of the output of the first 2f stage and thereby form a first intermediate stream encoded with a fourth complex element. The 4f stage comprises a plurality of second optical circuits, each second optical circuit arranged to act on the intermediate stream to perform an arithmetic operation on the fourth complex element, thereby encoding the intermediate stream with a fifth complex element. The 4f stage also comprises a plurality of intermediate input ports arranged in a fourth array, each intermediate input port arranged to be supplied with a corresponding one of the intermediate streams, thereby forming an intermediate function definable based on the value of the fifth complex elements and the position of the corresponding intermediate input ports in the fourth array. The intermediate input ports are arranged to provide an optical input to the second 2f stage.

The intermediate output ports are arranged at the output plane of the first 2f stage so that an intermediate output function which is the Fourier transform of the aforementioned input function is sampled by the intermediate output ports. The intermediate output function is definable based on the values of the fourth complex elements encoded onto the intermediate streams and the position of the corresponding intermediate output ports in the third array.

The intermediate input ports are arranged at the input plane of the second 2f stage so that an intermediate input function is input to the second 2f stage. The intermediate input function is definable based on the values of the fifth complex elements encoded onto the intermediate streams and the position of the corresponding intermediate input ports in the fourth array.

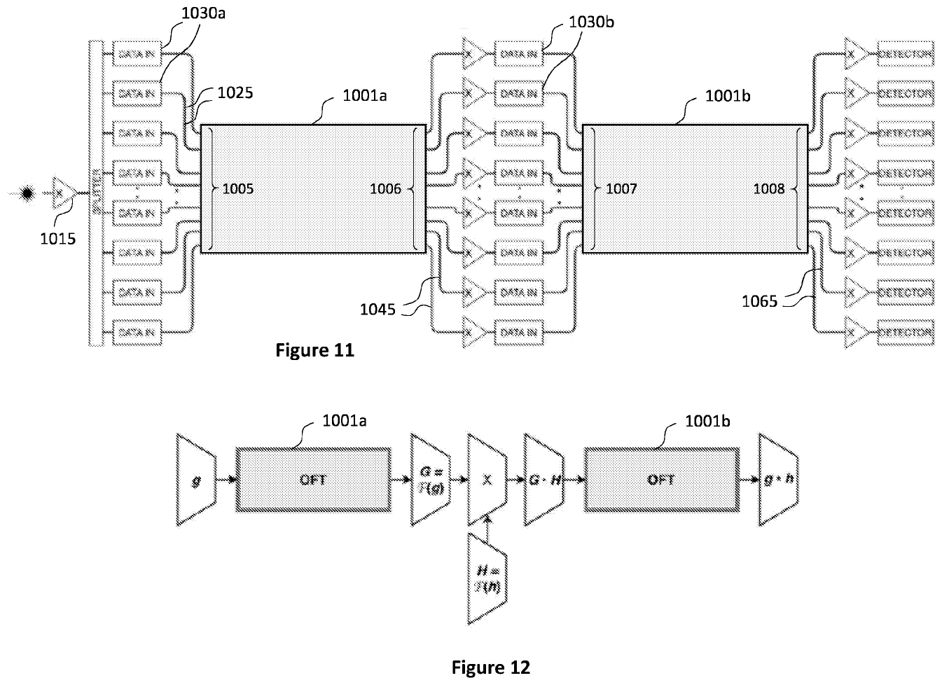

FIG. 11 shows a specific example of a 4f circuit embodying the principles of the 4f stage described above. The 4f stage comprises a first 2f stage 1001a and a second 2f stage 1001b. The input to the first 2f stage 1001a and the output from the second 2f stage 1001b are structurally as described for the input and output, respectively, of the optical Fourier transform stage described with reference to FIG. 10a and therefore a detailed description of identical components will be omitted here, except to note that the encoders referred to in FIG. 10a are labelled ‘first encoders’ 1030a with reference to FIG. 11.

FIG. 11 shows a plurality of intermediate output ports 1006 arranged in a third array. Each intermediate output port is arranged to receive a portion of the output of the first 2f stage and thereby form a first intermediate stream in an intermediate waveguide 1045, wherein the intermediate streams are encoded with a fourth complex element. The 4f stage comprises a plurality of second encoders 1030b, each second encoder 1030b arranged to act on the intermediate stream to perform an arithmetic operation on the fourth complex element, thereby encoding the intermediate stream with a fifth complex element.

Each second encoder 1030b is arranged to encode an additional complex element onto a stream of light. If the arithmetic operation is a multiplication, each second encoder 1030b is simply arranged ‘in line’ (or in series) in the optical waveguide carrying the intermediate stream. Thus, the aforementioned optical circuit in the general description of the 4f stage comprises simply the second encoder and no other encoders (in other words, each optical circuit is replaced with a second encoder).

The 4f stage of FIG. 12 also comprises a plurality of intermediate input ports 1007 arranged in a fourth array, each intermediate input port arranged to be supplied with a corresponding one of the intermediate streams (or other streams encoded with the fifth complex element, for example the intermediate stream combined with the separate stream in the case of addition), thereby forming an intermediate function definable based on the value of the fifth complex elements and the position of the corresponding intermediate input ports 1007 in the fourth array. The intermediate input ports 1007 are arranged to provide an optical input to the second 2f stage 1001b.

In some embodiments, each second encoder is arranged to act on the intermediate stream to multiply the fourth complex element with an additional complex element in order to encode the intermediate stream with the fifth complex element.

FIG. 12 is a schematic showing complex mathematical functions represented in a 4f stage comprising the first and second 2f stages 1001a, 1001b as described with reference to FIG. 11. In FIG. 12, convolution is performed using the 4f stage, wherein initially, the OFT of a function g is calculated optically, the OFT being an intermediate output function G=F(g). The OFT results (G) are then optically multiplied by another function H=F(h), which has been pre-calculated (and optionally retrieved from a memory). This produces the intermediate input function G·H. The convolution g*h is calculated after OFT of the product of the multiplication G. H. Using this approach, the signal processing stays within the optical/photonic domain; albeit a preprocessed OFT multiplier function H (also referred to herein as an additional function) is required.

In more detail and with reference to FIGS. 11 and 12, an input function g to the first 2f stage is definable based on the value of the first complex elements encoded onto the input streams and the corresponding positions of the input ports 1005 in the first array. The first 2f stage 1001a performs an optical Fourier transform of the input function to form an intermediate output function G=F(g). The intermediate output function G=F(g) is definable based on the value of the fourth complex elements encoded onto the intermediate streams and the corresponding positions of intermediate output ports 1006 in the third array. The intermediate output function is then multiplied by an additional function H=F(h) applied to the intermediate streams. This can be done by using the second encoders 1030b to encode additional complex elements onto the intermediate streams, which are themselves already encoded with the fourth complex elements. As described above, this results in fifth complex elements being encoded onto the intermediate streams when the reach the intermediate input ports 1007 providing the input to the second 2f stage. The additional function H=F(h) is definable based on the value of the additional complex elements and the positions of the intermediate output ports 1007 corresponding to the intermediate streams onto which the additional complex elements are encoded. The result of the multiplication of the intermediate output function G=F(g) and the additional function H=F(h) is the intermediate input function G·H. The intermediate input function G·H is definable based on the value of the fifth complex elements and the positions of the corresponding intermediate input ports 1007 in the fourth array. The second 2f stage then performs an optical Fourier transform of the intermediate input function G·H to provide the output function g*h (the convolution of g and h). The output function is definable based on the value of the second complex elements encoded onto the output streams and the corresponding positions of the output ports 1008 in the second array.

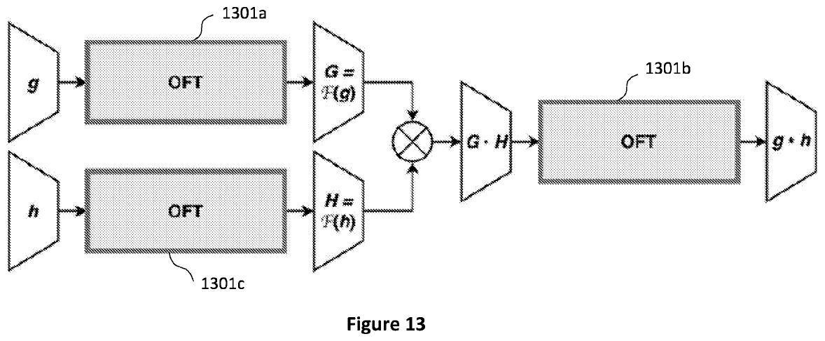

An alternative method of optically calculating the convolution of two functions g*h is shown in FIG. 13. FIG. 13 shows a method of convolution using a modular rearrangement of a first 2f stage 1301a, second 2f stage 1301c and third 2f stage 1301b. Each of the first, second and third stages may be of the form described with reference to FIG. 10a. The first and second 2f stages are used to optically calculate the OFT of a first input function g and a and second input function h to respectively provide a first intermediate output function G=F(g) and a second intermediate output function H=F(h). The results are then multiplied electronically (for example using a feedforward circuit) to obtain an intermediate function i=G·H. The multiplied electronic result is then encoded back into the optical domain and is subsequently inverse Fourier transformed using the third 2f stage, to calculate the convolution l=F(i)=g*h. Using this approach, the OFT of both functions can be calculated during runtime, albeit with an electronic multiplication stage. That is, the functions g and h can be received and processed simultaneously, which can speed up operation and which negates the need to store/fetch previously calculated values of H in contrast with the process described with reference to FIG. 12.

All functions described herein are mathematical functions defined by complex elements. The output functions may be defined by full complex numbers (therefore may be referred to as complex output functions). The input functions may be complex functions if the encoded complex elements are full complex numbers. The input functions may be real functions if the encoded complex elements are components of complex numbers.

### III—Controllers

### Compensating for Phase Effects and Photonic Device Characteristics

A more sophisticated form of optical computing system, capable of performing complex operations, has been described. As noted above, the present inventors have identified that optical computing systems of increased sophistication, such as those of the present disclosure, are impacted by phase effects which do not adversely impact less sophisticated optical computing devices. In more detail, the photonic devices of the disclosed optical computing system are liable to undergo so-called “phase drift”, for example as a result of environmental factors such as temperature. This phase drift impacts the behaviour of the light used by the photonic devices to perform operations and arithmetic. More specifically, because the presently disclosed system utilises the phase of light to encode complex numbers, phase drift of the photonic device(s) will impact this process and affect the associated calculations. Therefore, the present inventors have devised mechanisms for compensating for such phase effects to enable reliable and accurate computation. These mechanisms will now be described in detail with respect to FIGS. 14-22.

Turning first to FIG. 14, an example of a system for correcting for phase effects, such as phase drift, of the photonic devices of the optical computing system is shown schematically. An example chiplet comprising at least four schematic building blocks 1401, 1402, 1403, 1404 is shown. A digital backend 1401 of the chiplet comprises a suite of driver electronics, digital backend logic and a digital interconnect, and allows data exchange to and from the chiplet. In practice, data will typically be received from a data bus of a digital computing element. Connected to the digital backend 1401 of the chiplet is a controller 1402 of an optical encoder of the chiplet. The controller 1402 may alternatively be referred to as an optical driver or encoder driver. The controller 1402 enables data streaming through the chiplet and feeds signals into photonic devices in a photonic integrated circuit (PIC) 1403 of the chiplet. The PIC 1403 is connected to the controller 1402 of the optical encoder and comprises at least one photonic device which enables optical arithmetic operations, optical Fourier transform (OFT) and convolution to be performed on complex mathematical elements or numbers.

It will be appreciated that controller 1402 may be included as part of the encoders of any of the arrangements described with reference to any of FIGS. 3a-6d (continuous and inclusive). Similarly, PIC 1403 may be any of the PICs or optical apparatuses described with reference to FIGS. 9a-13 (continuous and inclusive). The controller 1402 can take the form of any of the controllers described with reference to FIG. 15, 16 or 17.

Feedback 1404 from the PIC 1403 is fed back through to the controller 1402 of the optical encoder. In this example, feedback 1404 provides an offset voltage, set by feedback logic, to the controller 1402. Feedback signal 1404 may be used to modify the signal provided by controller 1402 to PIC 1403, in the manner that will be described in further detail below. Where this happens periodically or continuously, the arrangement of FIG. 14 may thereby form a continuous or periodic feedback loop. The operation of the PIC 1403 is, in this example, controlled with a dedicated state machine that controls, monitors, and optimises the electronic control of the photonic devices in the PIC 1403 to maximise efficiency, reduce data latency and improve throughput. To this end, the PIC 1403 is hybrid or co-integrated with the digital backend 1401 via the controller 1402. The feedback signal provided by feedback 1404 from the PIC enables the system to maximise the performance of the multi-bit operation of the photonic devices.

With this generalised overview in mind, more complete example embodiments of the controller 1402 of the optical encoder will now be described.

FIGS. 15 and 16 provide first and second example embodiments showing flows of signals through components of the controller 1402 of the optical encoder. FIGS. 15 and 16 are shown in a linked manner for ease of understanding and to show which common components (e.g. power management and feedback logic modules) feed signals to which components in each respective embodiment. It will be appreciated that the linking of the two arrangements is, however, merely schematic and, in practice, one or the other arrangement may be provided in isolation.

In both the arrangements of FIGS. 15 and 16, each photonic device is fed a signal via an optical encoder. In relation to FIGS. 15 and 16, only a single optical encoder shall be described, for simplicity, however there may be more than one optical encoder. The optical encoder may comprise an encoder driver which receives an electronic input signal from an interface, wherein the value of the electronic signal is based on a complex element. The optical encoder in this example comprises at least one buffer, or more specifically at least one First-In-First-Out (FIFO) which formats and organises data. The interface may comprise a digital input and output (DIDO) board or module. The received electronic signal may be a multi-bit signal or a bitstream of data from the interface, or more specifically from data backend logic of the digital backend 1401.

Within the optical encoder, the received electronic signal is, in the embodiment of FIGS. 15 and 16, split into two components, a first signal component and a second signal component. The second signal component is an inverted version of the first signal component, providing a push-pull signal. The received electronic signal may, therefore, be modified or inverted in some way before being output at or supplied to a photonic device. FIGS. 15 and 16 provide two example embodiments of how the received electronic signal is split and inverted to be supplied to the photonic device. FIG. 15 shows an embodiment using a push-pull amplifier configured to invert the second signal component in the analogue domain whereas FIG. 16 shows an embodiment using an inverter configured to invert the second signal component in the digital domain. If the second signal component is inverted in the digital domain, i.e. if the arrangement of FIG. 16 is used, then the circuit may advantageously be simplified because there is no need for additional circuitry components which are required when inverting the signal in the analogue domain. In the present example, one signal component is respectively provided to each of two contacts of a photonic device. For example, a first signal component may be provided to a first photonic device contact, and a second signal component may be provided to a second photonic device contact (the first and second photonic device contacts being contacts of the same photonic device). In other examples, this may vary. For example, in other embodiments, a first signal may be provided to the first photonic device contact and the second photonic device contact may be connected to a ground or reference voltage line.

Turning now to FIG. 15 in greater detail, in this example arrangement the received electronic signal from the FIFO is a digital electronic signal and is stored in a digital buffer. The received electronic signal is then output from the digital buffer to a Digital-to-Analogue Converter (DAC) to convert the received electronic signal to an analogue electronic signal. The output of the DAC is AC coupled to adjust a DC offset of the analogue electronic signal. In other words, the received digital electronic signal is ultimately converted into an AC coupled analogue electronic signal. The DAC may be accompanied by a sample and hold circuit to capture and hold the analogue signal until the following circuit, or more specifically the VGA, is ready to process it. A sample and hold circuit holds the value and only changes output value when new data is retrieved from the FIFO.

The controller 1402 in this example is configured to amplify the received electronic signal using a variable gain amplifier (VGA). However, it may be understood that, depending on the voltage range supported by the DAC, a VGA may or may not be included. The received electronic signal is then output from the VGA and is split into a first signal component and a second signal component. Splitting the electronic signal in this manner forms a push-pull signal. The second signal component is inverted using a push-pull amplifier resulting in the second signal component being an inverted version of the first signal component. In this example, the push-pull amplifier is configured to invert the second signal component in the analogue domain because the push-pull amplifier can drive two output levels. This means that inverting a signal is possible. However, push-pull amplifiers can cause the removal of AC coupling or the addition of DC artefacts. Therefore, if AC coupling of the second signal component is necessary, the second signal component may be adjusted for balance (or balance adjusted).

An adjustment signal comprising a voltage V_{BAL} can be provided to the controller 1402 to provide such a balance adjustment, in other words to adjust a DC offset, DC artefact and/or lack of AC coupling of the second signal component. This adjustment is designated “Balance Adjust” in FIG. 15, and the supply of the V_{BAL} adjustment signal is shown in FIG. 17. In this manner, the second signal component is modified based on the received adjustment signal V_{BAL} to generate a modified second signal component. The adjustment signal may comprise the mean voltage of the desired peak-peak swing voltage.

This V_{BAL} adjustment is, in the present example arrangement, dependent on the voltage swing required by the controller 1402 and can be set by firmware, for example implemented by power management logic as shown schematically in FIG. 15. Advantageously, the firmware can be configured to account for the type of photonic device to which the controller 1402 is connected. This can in turn influence the V_{BAL} signal provided. Put another way, the adjustment signal V_{BAL} can be dependent on the type of photonic device used in the optical encoder and can thus allow the controller to adapt to the type of photonic device.

The controller 1402 may be further configured to modify the received electronic signal to compensate for a phase shift induced by the push-pull amplifier of the optical encoder. Such an adjustment is shown and designated as “Centre Adjust” in FIG. 15. In this embodiment, the first and second signal components of the electronic signal are adjusted to correct a phase shift imparted on the AC coupled analogue electronic signal by active components in the circuit, such as the push-pull amplifier. Analogue delay lines may be used to match the phase of the signal.

To enable such an adjustment to be provided, an indication of a dynamic operating range V_{CENTRE} of the photonic device is received by the controller 1402, as shown in FIG. 17. The received electronic signal is modified based on the received indication of the dynamic operating range V_{CENTRE}. This process may be referred to as the signal being “centre adjusted”. As in the case of V_{BAL}, the indication of a dynamic operating range V_{CENTRE} can be set by firmware which, as noted above, can be configured to account for the type of photonic device to which the controller 1402 is connected. Put another way, the adjustment signal V_{CENTRE} can be dependent on the type of photonic device used in the optical encoder. Further, as the received electronic signal is split into two components, the centre adjust correction performed in this embodiment comprises adjusting the first and second signal components such that their swing voltage spans the dynamic operating range of the photonic device and to ensure adherence to signal-to-noise and bit-precision/accuracy specifications outlined for the photonic devices are met.

As noted above, the adjustment signal V_{BAL} and the indication of a dynamic operating range V_{CENTRE} can be provided by firmware which can take into account the type of photonic devices being used by the optical encoder. For example, different photonic devices may require different dynamic voltage ranges to function properly. The adjustment signal V_{BAL} and the indication of a dynamic operating range V_{CENTRE} allow such changes to the dynamic voltage range to be made when providing the input signal to the photonic devices. As a result, the same controller 1402 can be used for a variety of different photonic devices. If a new photonic device is to be used, the controller 1402 firmware can simply be updated to modify V_{BAL} and V_{CENTRE} accordingly. This avoids the need to use a different type of controller 1402 for each type of photonic device or to design multiple controller circuits for different specific photonic devices. Typically, the adjustment signal V_{BAL} and the indication of a dynamic operating range V_{CENTRE} can be set by a power management block operating the aforementioned firmware, where said power management block controls the voltage lines in the circuit(s) of the controller 1402. This is shown schematically in FIG. 17.

Turning back to FIG. 15, a final adjustment is shown, designated as “Offset Adjust”. This adjustment involves the controller 1402 receiving a feedback signal based on a phase drift associated with the photonic device of the optical encoder. In response to this feedback signal, the controller 1402 modifies the received electronic signal based on the received feedback signal to generate a modified electronic signal (which may be referred to as an offset adjust), and supplies the modified electronic signal to modulate the photonic device. The feedback signal is received as an offset voltage V_{OFFSET} provided via or set by feedback logic, as shown in FIG. 17. In the present example where the electronic signal comprises two components that have been split, the received electronic signal is modified by adjusting the first and second signal components to offset the phase drift associated with the photonic device.

The adjustment processes described above (designated as Balance Adjust, Centre Adjust, and Offset Adjust) may be implemented as feedback loops. In particular, a signal may be output from the controller 1402 to the photonic device, as shown in FIG. 14. The effect of that signal on the photonic device may then be assessed, through monitoring of the photonic device. Based on this monitoring, the system may determine (e.g. via firmware operating feedback and/or power management logic) that an adjustment is required. This adjustment can then be effected via the above-described Balance, Centre, and Offset adjustments to generate a modified signal. This circular feedback loop may then repeat, such that each feedback signal received by the controller 1402 is based on the effects of a modified electronic signal previously supplied to the photonic device by the controller 1402. This provides the feedback loop shown schematically in FIG. 14. It will be appreciated that, in practice, the Balance Adjust, Centre Adjust, and Offset Adjust signals may each be provided in the form of a respective input voltage to a circuit of the controller 1402, as shown in FIG. 17.

Turning now to FIG. 16, an alternative arrangement of how the controller 1402 of the optical encoder can be implemented is shown. The flow of FIG. 16 is similar in many respects to that of FIG. 15, with some notable differences.

In FIG. 16, the received electronic signal from the FIFO is a digital electronic signal and is once again split into a first signal component and a second signal component. Splitting the signal forms a push-pull signal. As in the arrangement of FIG. 15, the second signal component is inverted, in this case using an inverter, resulting in the second signal component being an inverted version of the first signal component. However, unlike the arrangement of FIG. 15, splitting and inverting of the signal both occurs in the digital domain in FIG. 16. The inverter in this example is a digital inverter. As a result of performing the inversion in the digital domain, there is no need for a Balance Adjust to take place, in contrast to the arrangement of FIG. 15. Accordingly, the adjustment signal V_{BAL} is not required because the received electronic signal is still a digital electronic signal. This simplifies the circuitry of the controller 1402 when compared with the push-pull amplifier embodiment of FIG. 15.

Following inversion, the arrangement of FIG. 16 then involves the first and second signal components propagating to two digital buffers. Each of the digital buffers outputs either the first signal component or the second signal component to one of two DACs to convert the first and second signal components of the received electronic signal to analogue electronic signals. Each of the DACs may be accompanied by a sample and hold circuit to capture and hold the analogue signal until the following circuit, or more specifically the VGA, is ready to process it. A sample and hold circuit holds the value and only changes output value when new data is retrieved from the FIFO. As in the case of FIG. 15, the controller 1402 in this example is then configured to amplify the received electronic signal using a variable gain amplifier (VGA).

Also like the arrangement of FIG. 15, the received electronic signals are then output and undergo a Centre Adjust procedure, such that they are AC coupled to adjust a DC offset of the analogue electronic signals. In other words, the first and second signal components of the digital electronic signal are converted into AC coupled analogue electronic signals, as described above in relation to FIG. 15.

As described above, an indication of a dynamic operating range V_{CENTRE} of the photonic device is received. The received electronic signal is modified based on the received indication of the dynamic operating range V_{CENTRE} (or centre adjusted). The indication of a dynamic operating range V_{CENTRE} is set by firmware which is dependent on the connected photonic device. Further, as the received electronic signal is split, the received electronic signal is modified by adjusting the first and second signal components such that their swing voltage spans the dynamic operating range of the photonic device. The indication of a dynamic operating range V_{CENTRE} can be set by a power management block and allows the circuit to be reused for a variety of different photonic devices instead of using a different circuit for each photonic device, as described with reference to FIG. 15.

Also as in the case of FIG. 15, the signals then undergo an Offset Adjust whereby the controller 1402 receives a feedback signal based on a phase drift associated with the photonic device of the optical encoder, modifies (or offset adjusts) the received electronic signal based on the received feedback signal to generate a modified electronic signal, and supplies the modified electronic signal to modulate the photonic device. As described in relation to FIG. 15, the feedback signal is received as an offset voltage V_{OFFSET} provided via or set by feedback logic, as shown in FIG. 17.

In the present example where the signal comprises two components that have been split, the received electronic signal is modified by adjusting the first and second signal components to offset the phase drift associated with the photonic device.

As described in relation to FIG. 15, the process of FIG. 16 can take place as part of a feedback loop, where a previously modified signal provided by the controller 1402 to the photonic device informs the next “loop” of modifications, provided via the Centre and Offset adjustments.

Unlike driver circuits used in traditional data communication applications, the example push-pull and data inversion optical encoder circuits used to implement the controller flow shown in FIGS. 15-16 account for the dynamic adjustment of drive signals using at least one of an adjustment signal V_{BAL} and an indication of a dynamic operating range V_{CENTRE}. The swing voltage of the photonic devices spans their dynamic operating range, or in other words, the voltage swing of a photonic device is centred around its dynamic operating range. This increases the data level separation in the optical signals generated using the photonic devices. Further, phase drifts are compensated for by modifying a received electronic signal based on a received feedback signal, where the feedback signal is received as an offset voltage provided via feedback logic. The feedback logic also sets the amplification of the VGA.

Turning now to FIG. 17, an example circuit for use in implementing controller 1402 is shown. Such a circuit may be used to control and carry out the signal flow shown schematically in FIG. 15. Various blocks are provided within the circuit to implement the functions described above with reference to FIG. 15. Resistors are denoted as R_{sub}, where the subscript “sub” indicates which functional block the resistors form a part of. Similarly, capacitors are denoted as C_{sub}, where the subscript “sub” indicates which functional block the capacitors form a part of. Supply voltages are denoted as V_{dd} and Vₛₛ where V_{dd} denotes a positive supply voltage and Vₛₛ denotes a negative supply voltage or a connection to ground. The use of “d” and “s” indicates drain and source, respectively. This means that the circuit provided is made using field effect transistors (FETs).

As can be seen, an input signal is received from a DAC as described in relation to FIG. 15. This signal is then amplified by VGA 1702. A split signal, comprising first and second signal components, then flows from VGA 1702 on two branches of the circuit.

As described in relation to FIG. 15, both components may be adjusted by Offset Adjust 1712 and Centre Adjust 1710 blocks, wherein the adjustments are controlled by the signals provided to the V_{OFFSET} and V_{CENTRE} terminals of the circuit.

The signal provided to V_{OFFSET} may be set using feedback logic 1708 which sets the offset based on a feedback signal indicative of a phase drift experienced by the photonic device of the optical encoder. This allows the Offset Adjust 1712 to modify the signal supplied to the photonic device in such a way that the modified input signal results in the photonic device operating in a way which compensates for or corrects said phase drift. This ensures proper functioning of the photonic device and, ultimately, allows for accurate and reliable computations.

The V_{CENTRE} adjustment may be set by power management logic 1706 which sets the centre adjustment based on the type of photonic device connected to the optical encoder, to which the output signal is to be supplied. This allows the Centre Adjust 1710 to adapt the signal supplied to the photonic device to account for particular requirements, characteristics and/or behaviours of the photonic device. If a new type of photonic device is connected to the controller 1402, V_{CENTRE} can be adjusted accordingly. This obviates the need to provide a separate, specific controller for each type of photonic device or for the controller to be modified wholesale when a new photonic device type is connected.

As also described in relation to FIG. 15, one of the split signal components may further undergo push-pull and Balance Adjust modifications. This is implemented in FIG. 17 through the push-pull driver 1704 and Balance Adjust 1714. As described in relation to FIG. 15, the Balance Adjust is controlled via terminal V_{BAL}. As in the case of Centre Adjust 1710, Balance Adjust 1714 allows the control circuit to adapt the signal supplied to the photonic device to account for particular requirements, characteristics and behaviours of the photonic device.

Following the various modifications described above, the two components of the processed signal are finally supplied to terminals V_{OUT1} and V_{OUT2} of the photonic device respectively. It will be appreciated that where more than one photonic device is provided, multiple copies of the circuit of FIG. 17 may be provided, each supplying the terminals of a respective photonic device.

In the case where the process flow of FIG. 16 is implemented rather than that of FIG. 15, the circuit of FIG. 17 can be provided with appropriate modifications. For example, the push-pull driver 1704 and balance adjust 1714 may be omitted, as these are not required in the process of FIG. 16.

The circuit may be further modified by using two DACs with sample and hold and two VGAs 1702 instead of one. The outputs of the VGAs would be fed into the rest of the control circuit comprising a Centre Adjust 1710 and a Balance Adjust 1714 and the two components of the processed signal would then be supplied to terminals V_{OUT1} and V_{OUT2} of the photonic device.

The optical encoder of this example is a mixed-signal circuit consisting of different logic families—for example, CMOS (complementary metal-oxide semiconductor) logic in relation to digital data and TTL (Transistor-transistor logic) in relation to the analogue circuit. Accordingly, appropriate signal integrity blocks (pull-up/pull-down resistor networks) are used to ensure that the signal integrity is preserved in the circuit.

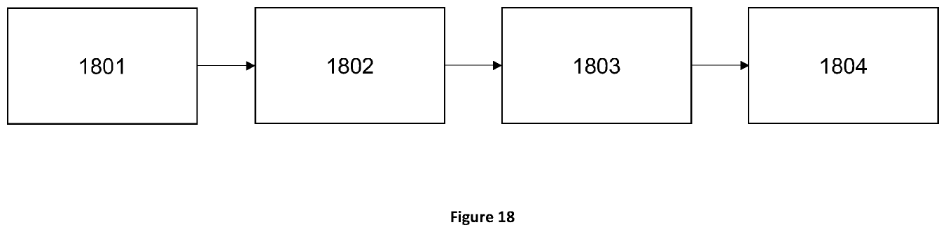

Turning next to FIG. 18, a method of the present disclosure is shown schematically. The method may be implemented by controller 1402 in order to supply an input signal to a photonic device of PIC 1403.

The method of FIG. 18 begins by receiving, at block 1801, an electronic signal, wherein a value of the electronic signal is based on a complex element. As described above, a “complex element” in this context may be understood to mean a complex number or a component of a complex number. The component of the complex number can be a real part or an imaginary part of a complex number or can be based on the real part or imaginary part of the complex number (for example the component could be the modulus of the real or imaginary part of the complex number or the positive or negative value of the real or imaginary part of the complex number). In this manner, method E provides a mechanism whereby a controller 1402 can provide input signals to a photonic device which enables the photonic device to encode and perform operations utilising complex numbers or components thereof.

The method then proceeds by receiving, at block 1802, a feedback signal based on a phase drift associated with a photonic device of the optical encoder. As described above, photonic devices, such as those of PIC 1403, experience phase drift due to environmental factors such as temperature. Such phase drifts, if not addressed, can impair the photonic devices' ability to perform accurate and reliable computations. The feedback signal received at block 1802 is configured such that it allows controller 1402 to modify the electronic signal being processed to compensate for any phase drift experienced by the photonic devices. The feedback signal may be set/provided via feedback logic which monitors the photonic device and quantifies or evaluates any phase drift experienced by the photonic device.

The method further comprises modifying, at block 1803 the received electronic signal based on the received feedback signal to generate a modified electronic signal. This may comprise modifying parameters of the received electronic signal in such a way that the phase drift of the photonic device, as indicated in the received feedback signal, is compensated for when the modified electronic signal is provided to the photonic device. In practice, the modification provided at block 1803 may be provided by providing an appropriate offset signal at V_{OFFSET} in the manner described above in relation to FIGS. 15-17.

Next, the method proceeds by supplying, at block 1804, the modified electronic signal to modulate the photonic device in a manner which compensates for or corrects the identified phase drift of the photonic device. This ensures that any such phase drift does not impair the photonic device's ability to perform accurate and reliable computations.

The method of FIG. 18 may be implemented as a loop, as already noted in relation to FIG. 14. In other words, feedback signals may be continuously or periodically supplied, for example via feedback logic, to controller 1402. Controller 1402 can thereby continuously or periodically update the signal it is providing to the photonic device, in order to continuously or periodically compensate for phase drift experienced by the photonic device. Continuing reliability of computation is thereby ensured.

It will be appreciated that the method of FIG. 18 may include additional blocks, in particular to compensate or adjust for other factors such as the type of photonic device being used in the optical encoder.

The method may comprise splitting the received electronic signal into a first signal component and a second signal component. The second signal component may be an inverted version of the first signal component. The method may comprise inverting the second signal component of the split signal in the digital domain or the analogue domain in the manner described above.

The method may comprise receiving an adjustment signal to correct a DC offset on the second signal component and modifying the second signal component based on the received adjustment signal to generate a modified second signal component.

The method may comprise modifying the received electronic signal by adjusting the first and second signal components to offset the phase drift associated with the photonic device. The method may comprise modifying the received electronic signal by adjusting the first and second signal components such that their swing voltage spans a dynamic operating range of the photonic device.

The method may comprise receiving an indication of a dynamic operating range of the photonic device and modifying the received electronic signal based on the received indication of the dynamic operating range.

The method may comprise amplifying the received electronic signal. The received electronic signal may be a digital electronic signal. The method may comprise converting the received (digital) electronic signal to an analogue electronic signal, using a digital to analogue converter (DAC).

The method may comprise AC coupling the analogue electronic signal to adjust a DC offset of the analogue electronic signal.

The method may comprise modifying the received electronic signal to compensate for a phase shift induced by a push-pull amplifier of the optical encoder.

Supplying 1804 the modified electronic signal may comprise supplying a first portion of the modified electronic signal, wherein the first portion is fast moving. Supplying 1804 the modified electronic signal may comprise supplying a second portion of the modified electronic signal, wherein the second portion is slow moving. In this context, “fast moving” signals describe AC data signals. In this context, “slow moving” signals describe slow moving DC signals. Slow moving components of a circuit may generally comprise DC components.

Modifying 1803 the received electronic signal may generate the second portion of the modified electronic signal. The received electronic signal may be a multi-bit signal. The received electronic signal may be received via an interface and at least one buffer. The interface may comprise a digital input and output board.

FIGS. 19 and 20 provide first and second example embodiments showing flows of signals through components of a controller of an optical decoder. The optical decoder referred to herein may comprise any previously described optical decoder 850 and detector (or decoder) 1090 which is described with reference to FIG. 8a or 8b. The photodetector referred to herein may comprise any previously described photodetector 804.

In both the arrangements of FIGS. 19 and 20, the optical decoder receives an optical signal from an optical apparatus. For example, the optical signal can be the output stream received at an output port of any of the previously described OFT optical apparatuses. The two example embodiments are arranged to decode a complex element, for example the sign and absolute value of a component of a complex number, from each of the output streams based on at least one characteristic of the respective output stream. In the examples, a differential photocurrent from the balanced photodiodes is converted into electronic signals, or more specifically, digital electronic signals or digital data comprising one bit (or a sign bit) for the sign (or polarity) of the real and/or imaginary part and a multi-bit signal (or multi-bit word) for the magnitude (or modulus or absolute value) of the real and/or imaginary part. The digital electronic signal can also be called a binary number. In a binary number, the bit furthest to the left is called the most significant bit and the bit furthest to the right is called the least significant bit. The sign bit is generally the most significant bit of the binary number.

The circuit is realised either using a single-ended, or a differential ADC. FIG. 19 shows an embodiment where an analogue electronic signal is split into a third component and a fourth component. A single-ended ADC is configured to convert the fourth component into the modulus of the digital electronic signal and the remaining circuitry is configured to convert the third component into the sign bit of the digital signal. On the other hand, FIG. 20 shows an embodiment using a differential ADC configured to convert the analogue electronic signal into the sign bit of the digital electronic signal and the modulus of the digital electronic signal. The sign bit and modulus of the digital electronic signal is representative of the complex element that was encoded onto the optical signal received at the photodetectors.

In both embodiments, the received electronic signal fed into the optical decoder from the balanced photodetector is the difference in photocurrents from each of the constituent photodetectors that form the balanced photodetector. This current is both amplified and converted to a voltage signal using a transimpedance amplifier (TIA). If further gain of the voltage signal is required, a VGA amplifies the voltage signal. A high gain improves the accuracy of the voltage signal and may be beneficial when noise in the system is substantial. Following the amplifications by the TIA and VGA, the voltage signal (or analogue electronic signal) is then converted to a digital electronic signal using different methods in each of the embodiments of FIG. 19 and FIG. 20.

Turning to FIG. 19 in greater detail, after the voltage signal has been amplified where necessary, the voltage signal is split into two analogue components, a third component and a fourth component. The sign of the complex element is determined from the third component and the modulus of the complex element is determined from the fourth component to thereby determine the complex element encoded onto the optical signal received by the photodetectors.

For determining the sign of the complex element, a comparator is connected to a reference line and the VGA to compare a reference voltage with the voltage of the third component. The reference voltage is supplied via the reference line to the comparator and is set by power management components. The comparator then outputs a modified third component indicating which of the two voltages input to the comparator is larger. The comparator uses TTL logic so its output is a binary signal, or more specifically, a TTL signal. The voltage signal of the modified third component is negative if the voltage of the third component is lower than the reference voltage. For example, if the reference line is supplied with a reference voltage equal to 0, the output of the comparator would indicate that the voltage signal of the modified third component is negative if the voltage of the third component is less than 0. The output of the comparator is then converted from TTL logic to CMOS logic. A TTL CMOS pull-up receives the modified third component and converts it to a voltage level understood by CMOS logic. A TTL CMOS pull-up is essentially a resistor circuit which changes the voltage level of the received signal by connecting the unused input pins of a digital logic gate (e.g. a digital inverter) to a DC supply voltage to keep the input voltage of the resistor circuit HIGH. A change in voltage level is required because the values of HIGH and LOW voltage (or current) differ in relation to TTL logic and CMOS logic. The use of CMOS logic allows very low power consumption. It is also possible for the comparator to use another logic family, for which appropriate matching networks are placed to convert the comparator output to CMOS logic, but for this embodiment, the comparator uses TTL logic.

The digital logic gate in this embodiment is a digital inverter (or a NOT gate) and implements logical negation for CMOS conversion. So, the modified third component is inverted by the digital inverter to output a bit denoting the sign of the complex element (or a sign bit). This is used because the TTL CMOS pull-up circuit has a margin of error so the output (a sign bit) could be incorrect. Therefore, the digital inverter ensures that the sign is correct. If logic level 1 is used to represent negative numbers, the output of the digital inverter is the sign bit. On the other hand, if logic level 0 is used to represent negative numbers, then the output of the digital inverter is inverted again to determine the sign and output the sign bit.

When determining the modulus of the received signal, the fourth component is rectified using a rectifier circuit in the analogue domain to invert the polarity of the negative portion of the fourth component. In this manner, the magnitude of the fourth component can be tracked because the rectifier circuit clips the signal to ensure there is no negative portion, leaving only the magnitude (or modulus or absolute value). In this embodiment, the fourth component undergoes full-wave rectification which results in the inversion of the negative portion to ensure a single polarity. This therefore extracts the modulus of the signal. The modified fourth component is then fed into a single-ended ADC to convert the modified fourth component to a multi-bit word (which is a segment of a longer word defining the full complex number). A single-ended ADC is a unipolar device so it ranges from 0 to a positive value. The output from the single-ended ADC denotes the modulus of the signal. Two instances of this circuit is used, one for real and another for the imaginary term, to construct the full complex number.

Thus, the third component and fourth component are modified and output the sign and modulus in the form of a digital electronic signal. These signals are fed into separate digital buffers. The digital buffers output the sign bit or multi-bit word, respectively, to one of two FIFOs for storage. The sign bit and multi-bit word may be input into any of the previously described optical encoders as a digital signal.

Now turning to FIG. 20 in greater detail, in this example arrangement after the voltage signal has been amplified by the TIA and VGA components as described with respect to FIG. 19, the voltage signal is fed into a differential ADC. A differential ADC specifies a voltage range with a maximum (+) and a minimum (−). If the voltage signal fed into the differential ADC is within the specified voltage range, the output of the differential ADC is a digital electronic signal (or binary signal or digital number or binary signal or code). In optical computing systems designed to be compatible with integer numbers only, this is where the circuitry stops because realising the sign and modulus of an integer number is not required. The presently described system is capable of performing more sophisticated operations, because the output of the differential ADC can be decoded by separating the sign bit and the modulus of the number using signed output decoder logic. In this embodiment, signed output decoder logic is provided within a binary output decoder which splits the signal into a (single) bit signal (a sign bit), and a multi-bit signal (a multi-bit word, which is a segment of a word defining the full complex number). The value of the bit signal and multi-bit signal represent the sign and absolute value (modulus), respectively, of the complex element encoded onto the optical signal received at the photodiodes.

FIGS. 21 and 22 show detailed examples of the operation of the differential ADC and the binary output decoder. FIG. 21 illustrates an embodiment in which differential ADC output is signed, whereas FIG. 22 shows an embodiment in which the differential ADC output is unsigned. In both embodiments, the differential ADC is supplied with a reference signal and the voltage signal from the preceding components in the decoder. The reference signal specifies the aforementioned voltage range of the differential ADC. As described above, the differential ADC output is a digital number. This digital number can be signed or unsigned.

FIG. 21 shows the operation of the binary output decoder of FIG. 20 where the digital number is signed. If the signed digital number is negative, the binary output decoder sets the sign bit as negative, and if the signed digital number is not negative, the binary output decoder sets the sign bit as positive.

The sign bit of a signed digital number is the most significant bit. In this manner, if the sign bit of the signed digital number is 0, then the sign bit is negative and if the sign bit of the signed digital number is 1, then the sign bit is positive. The modulus of the signed digital number is realised as an absolute value (or absolute word or abs word) from the remaining bits of the signed digital number which is set as the modulus of the signed digital number.

FIG. 22 shows the operation of the binary output decoder of FIG. 20 where the digital number is unsigned. If the unsigned digital number is less than the differential ADC's code for 0, the binary output decoder sets the sign bit as negative, and if the unsigned digital number is more than the differential ADC's code for 0, the binary output decoder sets the sign bit as positive. In the binary output decoder, the input lines can either be logic level 0 or 1. In addition, one output line is HIGH at logic 1 while the remaining output lines are held LOW at logic 0. The combination of these input lines determine which output lines are held LOW at logic 0 and which output is HIGH at logic 1. The differential ADC's code for 0 identifies that this input line is set at logic 0, so the unsigned digital number determines which output line is HIGH at logic 1. So, the binary output that is HIGH when the unsigned digital number is input, identifies the sign bit. In this embodiment, the first input of the binary output decoder (the differential ADC) is 0 and the second input is set by the unsigned digital number. If the unsigned digital number is negative (i.e. logic level 0), the output line identifying the second input as logic 0 is HIGH at logic 1 and the sign bit is set as negative. On the other hand, if the unsigned digital number is positive (i.e. logic level 1), the output line identifying the second input as logic 1 is HIGH at logic 1 and the sign bit is set as positive. The differential ADC's code for 0 is then subtracted from the unsigned digital number and the modulus of the signed digital number is realised as an absolute value (or absolute word or abs word) from the bits of the unsigned digital number which are set as the modulus of the unsigned digital number. In an alternative embodiment, the logic can be reversed, i.e. the 0s are 1s (and the HIGHs are LOWs) and vice versa, in which case commensurate adjustments need to be implemented as will be understood by the skilled person.

The binary output decoder splits the signal into a fifth component (carrying sign) and a sixth component (carrying modulus). The fifth and sixth components can respectively be considered analogous to the third fourth components described with reference to FIG. 19 in that they comprise the sign bit and the multi-bit word, respectively. These fifth and sixth components are each fed into separate digital buffers. The digital buffers output the sign bit or multi-bit word, respectively, to one of two FIFOs for storage. The value of the sign bit and multi-bit word represent the sign and absolute value (modulus), respectively, of the complex element encoded onto the optical signal received at the photodiodes.

The described embodiments are provided for illustration purposes and are not intended to be limiting. As the skilled person will understand, various modifications can be made to the embodiments. The invention is defined by the scope of the appended claims.

1. A controller of an optical encoder, the controller configured to:
receive an electronic signal, wherein a value of the electronic signal is based on a complex element;
receive a feedback signal based on a phase drift associated with a photonic device of the optical encoder;
modify the received electronic signal based on the received feedback signal to generate a modified electronic signal; and
supply the modified electronic signal to modulate the photonic device.

2. The controller according to claim 1, wherein the feedback signal is received as an offset voltage provided via feedback logic.

3. The controller according to claim 1, configured to split the received electronic signal into a first signal component and a second signal component.

4. The controller according to claim 3, wherein the second signal component is an inverted version of the first signal component.

5. The controller according to claim 4, configured to:
receive an adjustment signal to adjust a DC offset on the second signal component; and
modify the second signal component based on the received adjustment signal to generate a modified second signal component.

6. The controller according to claim 4, further comprising a push-pull amplifier configured to invert the second signal component in the analogue domain.

7. The controller according to claim 4, further comprising an inverter configured to invert the second signal component in the digital domain.

8. The controller according to claim 3, configured to modify the received electronic signal by adjusting the first and second signal components to offset the phase drift associated with the photonic device.

9. The controller according to claim 1, configured to:
receive an indication of a dynamic operating range of the photonic device; and
modify the received electronic signal based on the received indication of the dynamic operating range.

10. The controller according to claim 9, configured to:
split the received electronic signal into a first signal component and a second signal component; and
modify the received electronic signal by adjusting the first and second signal components such that their swing voltage spans a dynamic operating range of the photonic device.

11. The controller according to claim 1, configured to amplify the received electronic signal.

12. The controller according to claim 1, wherein the received electronic signal is a digital electronic signal and the controller is configured to:
convert the received electronic signal to an analogue electronic signal, using a digital to analogue converter (DAC).

13. The controller according to claim 12, configured to AC couple the analogue electronic signal to adjust a DC offset of the analogue electronic signal.

14. The controller according to claim 1, configured to modify the received electronic signal to compensate for a phase shift induced by a push-pull amplifier of the optical encoder.

15. The controller according to claim 1, configured to supply the modified electronic signal by:
supplying a first portion of the modified electronic signal, wherein the first portion is fast moving; and
supplying a second portion of the modified electronic signal, wherein the second portion is slow moving.

16. The controller according to claim 1, wherein the received feedback signal is further based on a modified electronic signal previously supplied to the photonic device by the controller.

17. The controller according to claim 1, wherein the received electronic signal is a multi-bit signal.

18. The controller of claim 1, wherein the received electronic signal is received via:
an interface; and
at least one buffer,
wherein the interface comprises a digital input and output board.

19. An electronic to optical encoder comprising:
the controller according to claim 1, and
the photonic device referred to in claim 1,
wherein the photonic device is a modulator configured to apply a first element of modulation to an optical input signal based on the modified electronic signal; and
the first element of modulation is operable to encode the complex element onto the optical input signal to produce an encoded optical signal.

20. An optical computer or optical computer chip comprising the controller of claim 1.

21. A method for performing by a controller of an optical encoder, the method comprising:
receiving an electronic signal, wherein a value of the electronic signal is based on a complex element;
receiving a feedback signal based on a phase drift associated with a photonic device of the optical encoder;
modifying the received electronic signal based on the received feedback signal to generate a modified electronic signal; and
supplying the modified electronic signal to modulate the photonic device.
